(19) United States
(12) Patent Application Publication
(10) Pub. No.: US 2004/0109059 A1
(43) Pub. Date: Jun. 10, 2004

(54) Hybrid joint photographer's experts group (JPEG) /moving picture experts group (MPEG) specialized security video camera

(76) Inventor: Kevin Kawakita, Temple City, CA (US)

Correspondence Address: KEVIN KAWAKITA, 5812 TEMPLE CITY BL #100, TEMPLE CITY, CA, 91780, US

(21) Appl. No.: 10/706,662

(22) Filed: Nov. 12, 2003

Related U.S. Application Data
(60) Provisional application No. 60/425,180, filed on Nov. 12, 2002.

(51) Int. Cl. H04N 7/18

(52) U.S. Cl. 348/143

(57) ABSTRACT

FIG. 1 is a diagram of an unmanned, fully automatic, security installation with electronic pan and tilt functions, the focal plane array based motion sensor (120) of the hybrid simultaneous-mode MPEG X/JPEG X security video camera (100) is positioned to capture moving suspects, the moving suspect (800) is shown, the local area network (LAN) cable (804) is shown leading away from the hybrid MPEG X/JPEG X security video camera (100), a security room personal computer viewing station (808) is shown, lastly a digital computer tape video logging station (816) is shown.

### CROSS-REFERENCE TO MY RELATED PATENTED INVENTIONS

U.S. patent Pending application Ser. No. 09/638,672, Filing Date Aug. 15, 2000, Filed by Kevin Kawakita, “Add-on-Electronic Rear View Mirror For Trucks, Campers, Recreational Vehicles and Vans.” This patent application covers a type of man machine interface (MMI) for very intuitive integration of a four video-camera system aimed at the front, back, left, and right along with a unique four panel video display with the arrangement of bezel matrix buttons/touch screen buttons to facilitate natural and intuitive user interaction. The man machine interface (MMI) can be used with a GPS satellite navigation receiver in a ‘video telematics’ computer.

U.S. patent Pending application Ser. No. 09/999,589, Filing Date Nov. 15, 2001, Filed by Kevin Kawakita, “Crash Prevention Recorder (CPR)/Video Flight Data Recorder (V-FDR)/Cockpit Cabin Voice Recorder (CVR) for a Light Aircraft with an Add-on Option for Large Commercial Jets. This patent is a process patent which covers the aircraft use of a process of digital video flight data recording and a playback mechanism structure for both safety and entertainment audio/video which uses an entirely new type of extension to the Motion Picture Expert's Group IV (MPEG IV) in a cryptography “silhouette-like” hidden background scene cutting technique to very efficiently store both position data stamps, attitude data stamps, video channel data stamps, available channel data stamps, and electronic television guide like digital data for video channel selection and future program recording. This new process is used instead of ‘the prior art MPEG IV prescribed “descriptors” which are custom specialized use additions to either the standard MPEG II audio stream or the separate MPEG IV video stream (e.g. close captioning for the hearing impaired, teletext, electronic television guide information).

### U.S. PROVISIONAL PATENT APPLICATION 60/441,189,

Filing Date Jan. 21, 2003, Title: Digital Media Distribution Cryptography Using Media Ticket Smart Cards. This process patent for a system of prior art computers, prior art smart cards, and prior art cryptographic key algorithms concerns a method of using smart cards as portable cryptographic vaults to transport cryptographic keys used for digital media distribution giving many key legal attributes (‘12 legal attributes of digital data’) including decryption session keys (one-time secret keys called ‘play codes’), and paid for or free trial accounting charge counts (‘play counts’). These concepts within an additional federated key cryptography escrow system are necessary for legally and US Constitutionally controlled and fully legal distribution of digital media.

### BACKGROUND

1. Field of Invention

This patent is a utility patent in the field of electronics for digital audio/video cameras.

Specifically the field of the invention is fully automated and highly specialized audio/video cameras meant for security video camera use emphasizing suspect photographs and critcal time and motion studies.

A secondary use for the same technology in the same preferred embodiment but in a different field of application is for Hollywood movie digital audio/video capture to full digital video tape (e.g DV(R) brand) where high resolution JPEG I still photographs mixed in with motion MPEG IV digital audio/video is a very useful combination for entertainment purposes-with customer selection for photo-realistic glossy ink jet print-outs, advertising stills, black screen room accurate outline alignment, and many other uses.

2. Discussion of Prior Art

### Prior Art of Digital Color Still Cameras

The latest y. 2002 commercial, digital color still cameras use Joint Photographer's Expert's Group (JPEG) compressed digital video sometimes from JPEG 2000 (fast wavelet compression). A JPEG still color picture taking digital camera is composed of a computer on a chip or micro-controller (single chip computer consisting of a: central processor unit (CPU), plus integrated, on-chip, auxiliary, input/output (I/O) bus circuitry, plus ancillary interrupt and timing and memory circuits, plus a small amount of on-chip electrically erasable programmable read only memory (EEPROM) for computer program store, plus a small amount of on-chip static random access memory (SRAM) for temporary working data store. The camera body is composed of:

1). a traditional still camera body made of plastic or metal or both.

2). a traditional still camera optical lens. This may be ‘warm blooded’ hand or remote hand by a joy-stick control swept in azimuth and also raised and lowered in elevation in a ‘warm blooded’ hand or remote hand ‘pan and tilt’ operation. This camera lens may be operator ‘warm blooded’ hand or remote ‘warm blooded hand’ computer joy-stick control focused with the lens ‘warm blooded’ eye or remote ‘warm blooded’ eye focal point concentrated upon the charge coupled device (CCD) surface which analog video signals are converted to digital for showing upon a liquid crystal display (LCD).

Some or all of the optical lens lighting control properties may apply in inexpensive digital cameras up to more expensive digital cameras (single lens reflex digital cameras) of:

Optical lens—may be wide angle (general purpose), telescopic zoom (distance), or macro-scopic lens (close up) made of expensive optical quality glass with special often trade secreted anti-reflective coatings (e.g. boron compound coatings are the most expensive and effective),

Light reflection is reducible by expensive lens anti-reflective coatings (latest boron compound lens coatings) which cause reflected light to cancel out using designed for one-half optical wavelength delays with incoming light over relevant visible light frequencies,

Chromatic aberration is inescapable (different colors being different frequencies of light have different focal lengths which is somewhat compensated for by user manual settings for distance modes which correspond to closed loop servo-motor controlled lens and CCD auto-focus algorithm user selection),

White light (all Visible colors of light frequencies combined together) can be broken into specific visible light color frequencies with use of an optical filter such as a glass prism,

Spherical aberration is inescapable (different shapes have different focal lengths with only a single point being focused upon without image blurring).

An optical lens may be ‘warm hand’ contrast focused, remote ‘warm hand’ contrast manually focused, or completely auto-focused using several techniques:

Active ultra-sound auto-focus uses “warm blooded” hand “pan and tilt” motions and then high frequency sound from a mini-speaker is aimed at the focal subject which is reflected back and received in a microphone. The transit time [sec] divided by two and multiplied by the speed of sound in air [meters/sec] gives the distance [meters] to the subject. The distance is used to auto-focus the lens under factory table settings for distance to subject vs. focal length for a film/CCD camera. Sound is thrown off by early reflection when shooting images through glass windows, bars, or gratings. Sound may also reflect off of near-by walls. This is an older auto-focus method used by camera manufacturers and burglar alarm companies before y. 1987.

Active infrared (IR) auto-focus uses ‘warm blooded’ or remote ‘warm blooded’ hand “pan and tilt” and then multi-directional arrays of infrared (IR) diodes producing infrared heat aimed out at different directions are activated with a one-half shutter button user push, with one direction being the stationary or moving focal subject who appears within the viewfinder within a temporary bordered focus square and who may be up to a maximum of 20 feet away. The focus image heat is reflected back along with any natural ‘warm blooded’ body heat if present. The ‘warm blooded’ body heat and reflected IR diode heat is heat imaged upon a combined infrared/visible light CCD to give a reflected infrared (IR) “red hot-spot” heat image which is auto-focused upon using a closed loop servo-motor to fine-focus the lens using both digitized horizontal and vertical maximized image contrast readings as read from the CCD and the analog to digital converter (ADC). The user can pre-set the video camera for only one of close-up range (portrait), medium range (general use), distance range (mountain scenery), or bright image (over-exposure). The pre-set setting helps take care of spherical aberration in which different shapes do not focus at the same focal length. The user manual setting selects the servo-motor contrast focus area as read off the CCD and ADC. The ‘hot spot’ heat image (or strongest central heat image for multiple heat images) on the infrared/visible light CCD point (x,y) is used for contrast focus of visible light on the film/CCD (x,y) point using the closed loop servo-motor controlled lens. Chromatic aberration (different visible light frequencies (equivalent to visible light colors) have different focal lengths which is not the same as the infrared (IR) frequency heat image focal length) can cause problems if not taken into account. Inexpensive infrared/visible light CCD's as in low-cost, consumer video cameras use infrared (IR) frequency or heat image contrast auto-focus and assume that the visible light image will also be automatically focused as well at the same point. The heat image CCD focal point (x, y) can also be used only as an approximate visible light image CCD focal point (x′, y′) with passive visible light lens auto-focusing with the same closed loop servo-motor lens control circuitry, done to fine-focus using visible light frequencies for a much sharper image.

The infrared (IR) image auto-focus method is thrown off by near-by heat sources such as candles, by patches of very dark colors which absorb the heat, and by near-by glass and walls which reflect the heat.

NOTE: that no distance measurements to the target image are used in inexpensive IR auto-focus still digital cameras.

The distance to subject measurement is also known as the ‘machine vision’ problem which in y. 2003 is a well known difficult problem in robotics. Robots often use reverse 3-D to 2-D vision estimates obtained from two stereo vision 2-D video cameras converted to a 3-D computer vision digital computer model, which is looked at from a virtual computer created camera angle and a 2-D vision ‘slice’ across the z-axis is used to estimate distance to any target.

Laser distance devices such as geodesic ‘total stations (theodolite old fashioned angle measuring plus laser measuring plus GPS satellite navigation)’ used in land survey send out an aimed laser at a remote tribach (tripod) held reflecting mirror. The reflected laser beam sent out with a unique digital on/off light pattern returns to the total station and the laser angle orientation and laser distance using the laser speed of light delay timed with an inexpensive quartz local oscillator (LO) feeding a basic digital clock circuit which differences the time of transit from start to finish. The laser beam time of transit [approx. 1.0 nano-second/foot] times the speed of light [milli- meters/nano-second] divided by two gives the distance in milli-meters. Light travels about 1 foot per nano-second. Thus no means of calibration is needed between two different low-cost, non-oven temperature stabilized, quartz local oscillator (LO) clocks as would be needed on two entirely different total stations. If this type of between total station local clock calibration is required, the GPS satellite navigation system in well known prior art ‘GPS time transfer mode’ can provide accurate less than 20 nono-second level clock calibration between any two GPS receivers.

Low cost (consumer electronics retail price point) distance estimation which does not use expensive laser ranging, expensive RADAR ranging, use of target held remote radio frequency (RF) transmitters ranging is technically infeasible for ‘machine vision.’

Passive auto-focus for unattended visible light video cameras was developed under the Clinton Administration's Partnership for a New Generation of Vehicles in y. 1994 for use in automobile electronic rear view mirror video “lipstick” cameras. Passive visible light auto-focus is meant for unattended video cameras without benefit of a ‘warm-blooded’ or remote ‘warm-blooded’ hand ‘pan and tilt’ operation. The wide angle lens is permanently fixed at a medium range setting which produces blurry images for close-up and distance subjects due to spherical aberration. The closed loop servo motor and CCD algorithm is set at a central circle averaged contrast algorithm. A close-up would require a point focus contrast algorithm. A distance shot would require a whole field averaged contrast algorithm. The lack of a user pre-setting for close-up (portrait), medium range (general use), distance (mountain scenery), or over-lit image (over-exposure) causes focus problems upon these types of images even with fine-tune focus done with closed loop servo-motor control. Overly sun-lit images as measured at the CCD can have automatic diaphragm/iris (sphincter control) adjustments on more expensive ‘35 mm body’ digital cameras with expensive through the lens user viewable penta-prism, to reduce the lens aperture (opening diameter or pupil) and a shutter (CCD curtain) timing adjustment.

Very plain flat surfaces with visible light, also low contrast of monotone color such as painted walls throw this contrast auto-focusing technique off. Close-up shots really requiring a point contrast auto-focus algorithm, and distance shots really requiring a full CCD contrast average auto-focus algorithm, end up getting blurred images due to non-specific lens focus due to spherical aberration outside of the circular area used for averaged contrast auto-focus with a medium focus algorithm (different shapes focus at different focal lengths with only point focus clear). This is a problem for unattended security video cameras even with auto-focus mode with recording to digitally compressed MPEG IV images.

Most of the suspect image huge ‘video blur’ in old analog security video cameras using analog NTSC audio/video signals written to helical scanning VHS (R) analog tape comes from re-using the helical scanning VHS video tape more than ten times resulting in magnetic hysteresis (magnetic coercivity) losses on a non-correcting analog signal. The analog recordings on fresh VHS (R) tapes are usually clear. Some ‘video blur’ also comes from ‘analog to digital conversion (ADC)’ losses from using video ‘frame buffer’ PC editing tools which convert the analog composite signal (single cable) NTSC HSI color model photo to digital RGB color model for digital editing. This is done in popular PC PCI bus add-in cards called ‘frame buffer capture’ cards which have a cable input for analog composite NTSC audio/video from an old fashioned analog helical scanning camcorder.

The expensive pentaprism (mirrored reflection viewing chamber used to give both a non-mirror image and right-side up image through the actual camera lens for the camera user) is a very expensive module. The optical camera lens unavoidably optically inverts the non-mirror-image and rightside-up target image to mirror image and upside-down due to ray tracing studied in geometric optics. In low-cost digital cameras, the pentaprism is replaced by a liquid crystal display (LCD), with the lowest cost often disposable digital camera models using just a ‘through the glass’ separate glass view-finder's look straight through window. A dirt speck on the lens will be un-noticed. Light for chemical film by-passes the expensive pentaprism because a mirror-image and upside-down, transparent negative film image (which does not have to be upside down because it creates an upside down print which simply has to be hand turned by 180 degrees to right-side up for human viewing) is desired captured on film for eventually making of a non-mirror image and right-side up print positive on hardcopy photographic paper. Light images focused by an optical lens upon a CCD is also mirror image and upside down and must go through an “electronic mirror” function (bit reversal for each row and column of a frame) done at computer bus read-out from the CCD's analog to digital converter (ADC). Bit row and bit column reversal is done during read-out to the micro-processor/micro-controller because a non-mirror and non-upside down image is desired upon the LCD user display for aiming and also in the digitally compressed JPEG X still photo video signal.

A shutter or curtain mechanism is desired to protect the film/CCD due to either film exposure or else CCD ‘color blooming effects’ whereby the CCD's buckets overflow during bucket brigade clock-out of the analog picture after shutter button full triggering causing color streaking problems (see CCD specifics section below). A shutter may be missing in lower cost digital cameras in which a shutter button simply starts the CCD bucket-brigade image clock-out of the image from the CCD. The analog CCD with permanent digital memory replaces camera film and has almost the same functionality. Shutter (opening and closing curtain protecting the film/CCD from light) open operation sends the lens focused mirror-image and upside-down image directly to chemical film/CCD to give a mirror-image and upside-down film negative which is fine for film. For a newer digital video camera, light from a CCD is read off the closely connected and adjoining analog to digital converter (ADC) in an “electronic mirror” function (bit reversal per row and column of each frame) on its way to the micro-processor/micro-controller because a non-mirror and non-upside-down image is desired upon the LCD display for user aiming and also in the digitally compressed JPEG still video signal. JPEG digital compressed video can always be computer bit color inverted and also row and column order inverted in a computer dark-room operation (e.g. Adobe (R) Photo-shop) to create both positives and negatives and also user selected mirror-image/non-mirror-image and upside-down/right-side up images. This ‘electronic mirror’ function can be done automatically by reading bits off the analog to digital converter (ADC) behind the charge coupled device (CCD) in reverse bit row and column order into the micro-processor/micro-controller bus for transfer to the micro-processor/micro-controller.

Shutter speed (exposure curtain timing control) must be ‘warm blooded’ human hand or remote ‘warm blooded’ human hand usually joy-stick top ‘shoot’ button or keyboard controlled or else made automatic under electronic control based upon CCD real-time read-outs and closed-loop servo motor micro-processor/micro-controller controls of the shutter mechanism.

Diaphragm or iris (mechanical light circle before the pentaprism) which controls the light image opening diameter (aperture) must be ‘warm blooded’ human hand or remote hand switch or knob controlled or else made automatic under closed loop servo-motor electronic micro-processor/micro-controller control based upon over-exposure inputs from the CCD, digitization by the ADC and then read by the micro-processor/micro-controller.

Aperture (diameter of the hole controlled by the diaphragm/iris) is controlled by the diaphragm/iris.

Focal stop (f-stop) must be ‘warm-blooded’ human hand or remote hand controlled as a course focal length adjustment. This is a mechanical sliding in and out mechanism for a more expensive 35 mm lens camera with a pentaprism in which a CCD mechanism replaces the film mechanism. For a fully automatic digital camera in the higher cost range, a user power zoom button activated servo-motor controlled ‘slide in and slide out’ mechanism is used as in 35 mm-70 mm/105 mm power zoom camera for course focal length adjustment.

Fine focal length adjustment must be done with ‘warm blooded’ human hand or remote ‘warm blooded’ human hand through keyboard controls/joy-stick base switches or else done in fully automatic continuous mode. Fully automatic continuous mode does continuous fully automatic closed loop servo-motor automatic fine focus on a central field consisting of an arbitrary central circular field of contrast averaging which simulates medium distance for spherical aberration. The arbitrary central circular field for medium range contrast auto-focus compares to a point focus used for a close-up's distance spherical aberration (leaving anything else blurry) which also compares to the over-all CCD field's contrast averaging for an infinite distance spherical aberration (leaving close-up objects blurry).

Type of lens selection as for close-up, medium range (wide angle), or telescopic (distance shots) must be ‘warm-blooded’ human hand changed. Spherical aberration (focal length of geometric shapes are different) is solved by manual selection and changing to a different type of lens. Fully automatic video cameras can use wide angle lenses with user pre-settings such as close-up (portrait), medium range (general use), distance shots (mountain scenery), over sun-lit shots (over-exposure), shadowy areas without much room-light (under-exposure). Closed loop servo-motor controls for the diaphragm (aperture or light hole diameter) adjustment can automatically compensate for some exposure problems. This lack of human selection produces blurred images for fully automatic video security cameras factory set at mid-range when the suspect is close-up and when the suspect is at a distance which can be critical in crime cases for suspect identification. Very expensive fully automatic video cameras can use a motor controlled automated rotating circular lens assembly (e.g. favored in Hollywood spy movies) typically with a: macro lens for close-ups, a standard lens for general use, and a telephoto lens for far-off use. Medium priced digital cameras use a power zoom telescopic 35 mm-70 mm/105 mm lens activated by a user power zoom button to select the zoom position, ‘f-stop,’ or course focal length on expensive body cameras with manual changed specialty lenses, with fine auto-focus done with image contrast in the micro-processor/micro-controller.

Mechanical mirror (used to give a non-mirror image and non-upside down image through the expensive pentaprism mirror assembly with shutter closed for the camera user). In a pentaprism arrangement, light for the film by-passes the mirror because a mirror image and upside down negative image is desired for eventual use in making a hardcopy non-mirror image and right-side up print positive. In a digital camera, light from the ADC behind each CCD goes through an “electronic mirror” (bit reversal for each row and column of a frame) for non-mirror image and non-upside down LCD display and non-mirror image and non-upside down JPEG still video use. The analog to digital converter (ADC) behind a charge coupled device (CCD) can also be read in reverse bit row and column order into the micro-processor/micro-controller bus to do this “electronic mirror” function automatically.

3). For completely unattended operation cameras with no ‘warm blooded’ or remote ‘warm blooded’ hand ‘pan and tilt’ operation, a dedicated unit focal plane array motion sensor can be used at greater expense which has multiple infrared/visible light CCD's aimed at different directions, and even several CCD's aimed at different directions. The current drain is much higher especially with auto-focus mode on continuously.

For the lowest cost security video cameras, with only one or two active infrared (IR) diodes which reflect infrared heat off the ‘warm blooded’ ‘pan and tilt’ target image, a reflected off the target (maximum range is about 20 feet) infrared ‘hot spot dot’ is focused upon a combined, single, dedicated infrared (IR)/visible light CCD. The use of user selected auto-focus mode does this action continuously resulting in steady current drain and uses up battery current quickly by constantly projecting this small reflected ‘red’ image ‘hot spot’ upon the infrared (IR)/visible light CCD with servo-motor auto-focus. The closed loop servo-motor controlled lens can auto-focus upon the ‘hot spot’ which is user ‘warm blooded’ hand ‘pan and tilt’ aimed at the target image or else ‘pan and tilt’ aimed by the remote joy stick connected human.

Shutter lapse (programmed delay) can occur as the final lens auto-focus movements are done before the shutter curtain is opened (optional more expensive model internal mini-CD-R drive systems must also motor up for image storage upon mini-CD-R or alternate removable high density hard disk drives). Lens focusing upon the infrared reflected ‘hot spot’ will also focus upon the visible light subject near the ‘hot spot.’ A manual camera focus mode can be activated in better cameras which saves battery current and reduces shutter lapse delays, which usually requires the ‘warm blooded’ user pushing the shutter button down half-way in order to manually activate the infrared (IR) diodes while a ‘user aiming cue’ focus square or focus circle appears in the LCD display.

The infrared (IR) diodes can be arranged in arrays pointed in different outward angles with all diodes activated at the same time periodically to produce an infrared light wide-beam heat source. The combined infrared/visible light CCD can in more expensive camera units be separated into two specialized units of a dedicated and specialized infrared CCD (based on lower quantum efficiency with a built-in optical filter which lets through only infrared light or else a CCD coating which accomplishes the same goal), and a dedicated and specialized visible light CCD (based on higher quantum efficiency with built-in semi-conductor resistance to lower energy quanta, lower frequency infrared light). The single, combined, low-cost, infrared/visible light CCD will receive one reflected ‘hot-spot infrared diode’ red spot plus one or multiple body heat infrared frequency images transmitted by a ‘warm-blooded’ still or moving suspect(s) and at different heat intensity levels.

In prior art expensive military infrared imaging systems, the moving heat images at unknown distance are of interest and can be distinguished using a CCD x-y plane (x, y, image heat intensity) point. The focal plane CCD coordinate of (x, y, image heat intensity) can be assumed to be the focal point of the visible light image which ignores errors due to chromatic aberration (different frequencies have different focal lengths). With more expense and a sharper image, this infrared image focal point can be used as an estimate to do a separate visible light passive auto-focus using the same closed loop servo-motor image focus operation using visible light contrast inputs for the visible light image.

A computer motion model using heat image data can be maintained in a non-dedicated, advanced 512 Mega Hertz strong advanced reduced instruction setecomputing (RISC) micro-processor (strong-ARM) which needs peripheral support integrated circuits (IC's) in a two chip-set, or else a powerful future single chip strong-ARM micro-controller (single chip strong ARM computer), executing a computer motion model computer program using CCD coordinates of (x, y, image heat intensity, time) points for every moving heat image. The positive x-axis is across the camera with the positive y-axis being vertical down the camera with the origin at the center of the CCD. The infrared/visible light CCD focal plane CCD coordinate point of (x, y, image heat intensity) received from the computer motion model of the particular moving heat image of interest is used for visible light passive auto-focus using fine lens adjustments done with closed loop servo-motors. The 512 Mega Hertz strong advanced RISC micro-processor (strong-ARM) can run very through-put intensive object discrimination algorithms and clutter rejection algorithms. These are already used in prior art military infrared imaging systems.

The range to a particular motion model subject can also be estimated and kept in a multi-sensor or sensor data fusion computer motion model's multi-dimensional CCD coordinates. Ranging can be done with an array of ultrasonic speakers aimed outwards with an array of microphones to receive reflected sonar waves. The range estimate for a moving suspect is the time of the signal propagation divided by two times the speed of sound in air.

Prior art sonar uses are many. Complex military submarine digital sonar processing (DSP) for below water audio Doppler shift based upon velocity of the target which is called Doppler sonar, target shape discernment (object discernment) as in propeller blade shape, require a huge amount of floating point digital signal processing (DSP) in the Mega floating point operation per second (MFLOPS) range using million dollar dedicated digital signal processing (DSP) computers. P3 Orion US Navy sub-chaser turbo-prop planes use disturbances in very long-wavelength Navy atmospheric radar which penetrate deep into the water and are reflected back for course submarine location and air dropped sona-buoys for fine submarine location with air dropped depth charges used to sink an enemy submarine.

Low cost ultra-sonic sonar processing units can be used for simple air propagated sonar processing as are found in low-cost, consumer, electronic room dimension and square footage measurement devices (e.g. Zircon (R) room measuring sonar).

In prior art military infrared imaging systems, the computer motion model of all moving heat suspects will give a particular suspect CCD coordinate of (x, y, image heat intensity, time) used to do passive visible light lens auto-focus on the infrared/visible light CCD coordinate (x, y) point. This will locate the exact spot on the infrared/visible light CCD to do passive auto-focus done by adjusting the lens focal length at this particular spot for this particular moving suspect. Multiple moving suspects tracked by the computer motion model can be sequentially focused or else selectively focused by using ‘electronic pan and tilt mode’ or a single suspect and can computer motion model selected and followed with passive auto-focusing. The active infrared auto-focus is thrown off by heat emitting images such as candles or warm car mufflers. It is also thrown off by intervening glass or near-by walls which reflects heat. It also works for a moving suspect up to a maximum of fifteen feet away. The tank operator for example can use a touch-screen to ‘target designate’ a certain moving enemy heat image object in a battle-field full of glowing heat objects with some of the objects friendly objects and some of the objects foe objects. The battlefield is filled with fire and smoke which blocks visible light images in ‘the fog of war.’ High infrared (IR) signature moveable armor panel markings with secret daily geometries or secret daily number codes are used to identify friendly forces. Electronic identify friend or foe (IFF) units are used only on Navy jets and Navy ships due to high cost per unit. Military infrared systems often fail with extremely hot atmospheric conditions above 120 degrees Fahrenheit.

For completely unattended operation and no warm blooded or no remote hand “pan and tilt” operations, low-cost consumer, active infrared (IR) based motion sensors are used for energy saving, motion control sensor activated, house lighting and house burglar alarms. These units use a very inexpensive single IR diode or small directional cluster of IR diode transmitters with a single small IR CCD sensor. These systems measure changes in the heat image on the IR CCD to indicate motion with an infrared CCD sensitivity function used to avoid heater draft and house pets. The small white opaque plastic case protected CCD sensor returns a simple Boolean (yes/no) response of warm body heat image motion detected or not detected at the given sensitivity level. These Boolean IR motion sensors are easily thrown off by pet movements and heater air drafts despite sensitivity adjustments.

For completely unattended operation with no warm blooded or else with no remote hand ‘pan and tilt operation,’ passive infrared (IR), auto-focus still camera systems were also available in y. 2000. Passive infrared (IR) systems have no infrared transmitters (IR diodes) as the kind used in police helicopter infrared systems which can detect low human body heat infrared images up to one to two miles away on a cold day or chilly night. Moving or still body heat is received by a combined infrared/visible light sensitive charge coupled device (CCD). The body heat image on the CCD gives the exact CCD coordinate (x, y) locations where a passively focused visible light CCD can do what is called “passive CCD focusing” or the process of using fine auto-focus lens control to achieve a maximum visible light image contrast upon the CCD. Several moving heat images detected by the micro-processor/micro-controller at one time may force a broad field auto-focus mode, or low cost passively focused, combined infrared/visible light CCD at mid-range focus done with contrast averaging over a large central field area. The passive infrared auto-focus is thrown off by heat emitting images such as candles or warm car mufflers, intervening glass which reflects heat, or walls nearby a subject which also reflect heat. Passive IR is also thrown off by overly sun bleached images. Passive IR auto-focus (e.g. used in military night vision systems and for police helicopters) works with heat only images several miles away when a very sensitive IR CCD is used. These systems often fail with extremely hot atmospheric conditions above 120 degrees Fahrenheit.

Expensive dedicated focal plane array systems used in military infrared (IR) target tracking systems are dedicated to moving ‘object discrimination’ or ‘target discrimination’ with ‘clutter elimination’ algorithms can have dedicated infrared diode (IR diode) transmitter clusters, dedicated infrared only charge coupled devices (IR CCD's), and a shared or dedicated high instruction rate advanced, reduced instruction set 512 Mega Hertz, 32-bit computer (RISC) micro-processor (strong-ARM) to do computer motion model processing as well as the ‘object discrimination,’ ‘target discrimination,’ and ‘clutter rejection’ algorithms. The computer motion model must maintain for all stationary and moving heat images the focal plane CCD coordinates of (x, y, heat image intensity, time, optional range). Only one coordinate for an object of interest is fed to the visible light CCD for “electronic pan and tilt” operation using passive auto-focus.

4). a single visible light charge coupled-device (CCD) integrated circuit (IC) for analog red, green, and blue (RGB) pixel production has white image light focused upon it by a specialized Bayer filter. In y. 2002, the JPEG digital camera's CCD has a resolution of 3-6 Mega pixels/CCD depending upon camera cost and year of camera model introduction. Bayer filtering with a single CCD used for producing the RGB color model reduces the effective pixel density by a little less than ⅓. Three CCD systems use one CCD for red, one CCD for blue, and one CCD for green. Using True color mode ‘color grey scale’ of 10-bits red, 10-bits green, 10-bits blue, 2-bits don't care or 32-bits/pixel or 4 bytes/pixel (RGB color model) of digital color/pixel which is color model transformed in the micro-processor/micro-controller into the cyan (C), yellow (Y), magenta (M), black (K) or CYMK reflective light color model. The CYMK color model uses 1 bit/pixel at much higher pixel densities (commercial print resolutions are 600 dots/inch or dpi up to 3600 dots/inch on glossy paper or dpi, vs. 80 dots/inch or dpi for a CRT screen and 1200 dots/inch for an ink-jet printer) for four separate color layers with the black layer having most of the detail for border outlines and shading which makes the bits/pixel incomparable to the digital RGB color model?.

There is no need for JPEG hardware circuitry due to the low data rate of JPEG still photos of a maximum of 1 exposure/0.5 second. The micro-processor/micro-controller can be used for a firmware implementation of the JPEG I digital compression algorithm in typical digital camera lossy mode (other JPEG I modes are available) with the 8×8 discrete cosine transform (not compatible with MPEG X digital compression). JPEG I discrete cosine transform (DCT) for a single color layer out of the four CYMK color model layers does for a single picture frame a spatial domain to a single color frequency domain conversion with the high frequency color areas indicating ‘visually unimportant areas’ which can be lossy data eliminated for better digital data compression. Each CYMK color model color layer is individually digitally compressed with about an average 3 to 1 compression ratio (black does not compress as well having more detail, but, gives the greatest border and shading outlines). An additional non-JPEG I standard 10% extra Reed Solomon (RS parity coding) error detection and error correction parity bits are added for storage on permanent memory such as EEPROM cards. The CYMK color model uses (Boolean ON/OFF) one bit per pixel and is not grey-scale or y. 2003 true color mode of 32-bits/pixel as is used in MPEG IV video.

Canon (R) brand video camcorders use the cyan (C), yellow (Y), magenta (M), and black (K) or CYMK reflective light color model (JPEG I print color model) for enhanced black detail and shading detail for its audio/video camcorders recorded to digital video-tape, instead of the prior art digital color model alternates of MPEG IV's Yellow (Y), Cobalt Blue (Cb), and cadmium Red (cd) or YCbCd transmissive light color model. The CYMK reflective light color model used in the printing industry is valued for its very accurate color calibration and representation.

MPEG IV's YCbCr color model was modeled after the older British PAL analog TV signal based upon the YUV color model originally developed for rich human flesh tones and color accurate to the original human flesh tones upon which the human eye is very sensitive to color calibration errors. An alternate y. 2003 color model is the Sony (R) older Betacam (R) and optional SDTV used Yellow (Y), Plumbous Red (Pl), Prussian Blue (Pr) or YPlPr color model also still used by flat panel makers.

The resulting still frame, color, fully JPEG I lossy digitally compressed picture is about 4-8 Mega bytes/color frame. This gives 4-8 Mega bytes/color picture depending upon resolution which means that using a 32 Mega bytes/memory card will store 4-8 pictures, respectively. A 64 Mega bytes/memory card will store 8-16 pictures, respectively. A 128 Mega bytes/memory card will store 16-32 pictures, respectively.

The Bayer filter is a semi-conductor thin film transistor (TFT) deposition layer of visible light optical frequency filters which breaks up white light into small red, green, blue (RGB) clusters with a predominance of green light which the human eye has difficulty detecting from a lower number of human green eye color cones. CCD's were first developed by Bell Laboratory researchers from early gated, analog, semi-conductor memories called “bucket brigade devices.” The analog CCD image is clocked out by rows much like an analog black and white NTSC television camera image for each of red, green, and blue color layers. The CCD resolution is measured in [Mega pixels/CCD]. The latest y. 2002 low end commercial JPEG (JPEG I) still camera models use Bayer filtered single CCD's per camera with 3 to 6 Mega pixels/CCD. Y. 2000 model inexpensive JPEG (JPEG I) still cameras used Bayer filtered single CCD's per camera with 2 to 3 Mega pixels/CCD. At maximum resolution/picture of 3 Mega pixels/frame plus 10% for error detecting and error correcting Reed Solomon (RS) parity coding where each CCD pixel is a RGB color model using 32-bit true color value using 10-bits for red, 10-bits for green, and 10-bits for blue a total is achieved in the RGB color model of 13.2 Mega bytes/frame at the ADC. This must be micro-controller RGB color model/single picture frame converted into the JPEG I CYMK color model/single picture frame and then each CYMK color layer/single picture frame may typically be lossy digitally compressed using JPEG I (discrete cosine transform).

Absence of the Bayer filter necessitates the use of three CCD's, one CCD for red, one CCD for green, and one CCD for blue at a great increase in up to three times the cost for the camera of discounted over US 2,500 dollars per camera. However, a three CCD system has a great increase in color accuracy and finer resolution for each color which is desired for professional digital still camera work and movie video gear costing over y. 2002 $2,500 per unit. The costly three CCD per camera system is preferred for professional still camera and motion video work because of three times higher resolution for the same density CCD, moving images are more accurately captured, ‘border jaggy effects (see CCD details)’ introduced by Bayer filtering is absent, and the use of special colored optical filters in front of each CCD greatly reduces both ‘quantum efficiency problems (see CCD details)’ on each CCD dedicated to a single color frequency and also the problem of ‘color blooming effect’ which are weird unexpected streaks of color showing up for no apparent reason (see CCD details).’ The message is, ‘you get what you pay for.’ Professionals should pay three times more for professional quality equipment if your livelihood and professional reputation depends upon it.

A type of pre-Bayer filter method for still cameras was to use the CCD in fast sequence mode first for red, then for green, and then for blue light which would produce time distortions for moving images. This method for still subjects produced higher color resolution for a single CCD.

In a passively focused, charge couple (CCD) meant for fully automatic still and video cameras with no human operator intervention, the wide angle optical lens (to avoid need for ‘warm blooded’ or remote hand ‘pan and tilt’ operations) is connected to closed-loop servo-motor control circuitry which auto-focuses the lens upon the CCD using contrast inputs at a fixed medium focal distance user setting to the image as opposed to close ups or distance image shots user auto-focus settings. The CCD may be passively auto-focused by design which mimics the ‘warm blooded’ hand or remote human hand and ‘warm blooded’ human eyes or remote human eyes fine focus control by using image contrast with manual lens adjustment. A passive auto-focus CCD means that input contrast inputs from the lens focused image at the CCD/ADC acting as a closed loop servo-control ‘hold-box (H-box))’ are automatically measured by the micro-processor/micro-controller and averaged over a given area to produce a lens motor control value ‘gain-box (G-box)’ which is output over the micro-processor/micro-controller bus to a latch which controls analog circuitry to control the servo-motors to fine tune the lens's focal point with very rapid course and fine repetitions until the maximized contrast occurs at the pre-set, mid-range arbitrary central focal area. This is an arbitrary circular central field averaged focus area (vs. a single central point focus for a close-up shots for spherical aberration, vs. an entire averaged CCD field for a distance shot for spherical aberration). Since the passive auto-focus CCD is usually used with wide-angle lenses (to avoid “pan and tilt” operations) on unattended video cameras, the focal point is pre-selected at a fixed medium distance which averages the contrast focus over a central circular region. For ‘warm-blooded’ human hand or even remote operator hand use, the target focus image is set at mid-range for general use, at close range with a close-up manual operator setting, or at infinity range with a distance manual operator setting. A passively focused CCD always needs an image with sharp contrasts in black and white such as prison uniforms or color border contrasts in order to automatically focus and has problems focusing upon images such as walls of one color, blue sky, or overly sun bleached out images. The original passive process for auto-focus only looked at contrast in vertical lines which were put through an analog to digital converter (ADC) or digitized for holding in a digital latch (hold-box or H-box) and put through a digital micro-processor algorithm with the closed-loop servo-motor gain controls (gain-box or G-box) sent directly to a digital latch which activated the servo-motor analog circuitry. Newer passive auto-focus also looks at contrast in both vertical lines and horizontal lines at much finer quadrant line intervals.

CCD output clocked out of the ‘bucket brigade’ based Bayer filtered (RGB color model semi-conductor thin film deposition optical filters) CCD in analog signals of red (R), green (G), blue (B) with each analog color signal similar in form to an older analog NTSC black and white only (color intensity) video television signal. Each analog video for a single color signal must go to an analog to digital converter (ADC), an expensive extra integrated circuit (IC) for digitization through pulse code modulation (PCM), and then to DRAM storage of a complete digital RGB color model/single picture frame, where it is subject to incoming groups of eight rows further digital signal processing by micro-processor/micro-controller firmware algorithm as a digital RGB color model/single picture frame. The ADC is an expensive extra integrated circuit (IC), but, required by the analog CCD integrated circuit (IC) use.

Complementary metal oxide semi-conductor (CMOS) vision chips called ‘CMOS vision chips’ which are sometimes mistakenly called ‘CMOS CCD's’ were developed in the late 1990's under US patent by Stanford University's engineering school. These CMOS vision chips are all digital logic chips which offer a one chip solution, unlike the analog CCD's and thus the expensive separate integrated circuit of an analog to digital converter (ADC) is avoided. The entire CMOS vision chip with built-in micro-controller (single chip computer with a weak micro-processor, small permanent program store in EEPROM, small temporary program store in SRAM, I/O logic, programmable interrupt controller (PIC), memory address logic, counter timing circuitry (CTC), direct memory access (DMA) logic) along with digital control programs stored in micro-controller built-in banked-EEPROM can be reduced to one single integrated circuit (IC). Thus a CMOS vision chip is the lowest cost digital camera or else camcorder choice by reduced chip count of one chip. A single ‘CMOS vision chip’ does the functionality of three up to five integrated circuit (IC) count for a comparable CCD based camera (depending upon Bayer filtering to reduce three CCD's down to one CCD). The CMOS vision chips are widely used in very compact and inexpensive (under $100) color pin-hole cameras which are the size of a US dime while still needing two wire leads sending analog black and white NTSC video or else analog color NTSC video to a VCR (R) machine for recording. The CMOS vision chips are attractive because they produce direct digital output (digital RGB) and need no expensive, separate analog to digital converter (ADC) integrated circuit (IC). CMOS vision chips are related to fully digital CMOS computer memories. The use of CMOS vision chips for this invention will allow a one integrated circuit, lowest cost by ‘reduced IC count’ security video camera per lens.

The y. 2002 disadvantage of CMOS vision chips is that the image resolution [pixels per inch or Mega pixels/IC] and lighting requirements [lamberts] are poor compared to analog CCD's. Therefore, CMOS vision chips are not currently recommended for security camera work unless very small pin-hole size in a compact camera (US dime sized with a pin-hole lens) is paramount. Current bucket brigade CCD densities producing analog video signals are much higher than CMOS vision chip modified CMOS transistor gate with capacitor? charge bucket structures producing digital signals. The future densities of CMOS vision chips are unknown in y. 2003.

The CCD may image visible light spectrum only or visible light plus infrared (IR) light spectrum (heat) useful for in the dark heat images (colored red) for security cameras. Visible light images for security video cameras need flood-lighting at night for suspect identification.

5). The analog to digital converter (ADC) attaches directly to the either Bayer filtered one CCD system (RGB color model using semi-conductor Bayer filtering), or else a three CCD system (RGB color model with a dedicated color per CCD). The ADC receives the NTSC-like black and white analog video signal from the CCD(s) for a single color or visible light frequency. The analog video data in the time domain is pulse code modulated (PCM'd) into mono-chrome digital data still in the time domain. Each color layer of Red, Green, and Blue in the analog RGB color model from the CCD's is processed separately as a separate monochrome digital video signal. The output combined color digital RGB color model signal is still digitally uncompressed and is processed by the ADC in single rows of a single picture frame. A ‘JPEG X group of eight row of processed rows/single still picture frame’ from the ADC sitting in a first in first out (FIFO) buffer is sent out a latch by micro-processor/micro-controller built-in direct memory access (DMA) controller over the digital computer bus to the dedicated DRAM integrated circuit for the collection of a complete digital RGB picture/single still picture frame.

6). A computer on a chip or micro-controller is a computer's central processing unit (CPU) combined with integrated bus circuitry, ancillary memory addressing (RAS/CAS), counter timer circuitry (CTC), temporary small amounts of fast flip-flop based internal data memory (SRAM), direct memory access (DMA) circuitry (also used for DRAM memory refresh signaling), programmable interrupt controller (PIC), and permanent computer program memory (banked-EEPROM). Static random access memory (SRAM) is often used in embedded systems for small amounts of program storage memory because it retrieves and writes faster than synchronous dynamic random access memory (SDRAM) while avoiding the SDRAM need for periodic memory address strobing plus refresh cycles to prevent SDRAM amnesia. SDRAM in a separate chip is needed for large capacity as in manipulating 18 Mega pixel/still color picture frame which is about 6 Mega bits at 1 bit/pixel per color layer for a total of 18 Mega-bits/single still picture, or about 2.25 Mega bytes/CYMK color model frame for a non-Bayer filtered professional quality JPEG I still color digital photos excluding RS parity bit of about 10%. A Bayer filtered still photo would require about 0.75 Mega-bytes/single picture frame.

The micro-processor/micro-controller is needed to shuffle the audio/video digital data from the CCD's analog to digital converter (ADC) over the micro-processor/micro-controller input/output (I/O) bus to the computer data store consisting of dynamic random access memory (DRAM). The CCD's analog to digital converter (ADC) read-out bit reversal called the ‘electronic mirror’ function must reverse the mirror-image and upside-down image to non-mirror-image and right side up. In y. 2002, dynamic random access memory (DRAM) or much higher clock rate synchronous-DRAM (SDRAM) is available commercially at premium prices at 1 Giga bits/IC (128 Mega bytes/IC or 1 Giga byte=1 Giga bit×8 IC's). The static random access memory (SRAM) has four transistors/bit (¼^{th} current DRAM densities) arranged in a digital 4 transistor flip-flop instead of a one transistor gate and a one capacitor charge storage bucket. The result is that SRAM is much faster for firmware memory and has one-fourth the current memory densities of SDRAM/DRAM. Static RAM (SRAM) also needs no memory re-fresh cycles due to having no continuous current drain (DRAM/SDRAM needs periodic memory addressing by row address strobe (RAS) and current address strobe (CAS) plus a single direct memory access (DMA) channel used to send a current pulse out to re-charge the capacitors).

One single complete digital RGB still picture frame from the single Bayer filtered CCD or else three CCD's is collected in the DRAM only after analog to digital conversion (ADC). A groups of eight rows of digital RGB collect in the DRAM they can be JPEG I processed by the micro-processor/micro-controller. The micro-processor/micro-controller must convert the single color digital RGB picture in DRAM must still be color model converted (matrix transformed) into JPEG I's cyan blue (C), yellow (Y), magenta (M), and black (K) reflective light color model along with executing a typical lossy JPEG I discrete cosine transform (JPEG I DCT) digital compression upon each separate color layer. This can be done by the micro-processor/micro-controller's floating point firmware given the very low rate of the frame production limited to rapid snap-shot mode or about 1 frame/0.5 second given programmed ‘shutter lapse (shutter planned inactivation periods after a shutter release).’ No separate JPEG I dedicated circuitry is needed for a still camera. However in comparison, a MPEG X digital camcorder needs dedicated MPEG X circuitry in a separate integrated circuit (MPEG IC) or else a MPEG X silicon compiler library function in a more modern and lower cost by minimized IC count large lower cost, mixed circuit integrated circuit (mixed IC).

The micro-processor/micro-controller can take input 8 row groups/still frame of digital RGB and do very low-rate floating point calculation color model ‘matrix transform’ conversion from digital RGB into JPEG I's CYMK color model standing for: cyan blue (C), yellow (Y), magenta (M), and black (K). The digital CYMK color model frame is JPEG I digitally compressed using JPEG I discrete cosine transform (JPEG I DCT) firmware algorithms in the micro-processor/micro-controller's EEPROM due to the low rate of still photo data and up to 1 frame/1 second shutter rate allowed for processing each frame before the shutter is re-activated in ‘shutter lag.’ More expensive digital cameras have reduced shutter lag (‘you get what you pay for.’). The JPEG I digital compression in the most popular JPEG I compression mode, consists of doing for each separate CYMK color model layer a JPEG I defined minor lossy discrete cosine transform (DCT) (riot MPEG X compatible) or time-domain to frequency domain transform using an 8×8 DCT algorithm operating on 8 rows and 8 columns of pixels at once. The DCT is used to judge ‘visually unimportant’ areas of ‘high frequency color pattern noise’ which is data filtered out in lossy compression. The micro-processor/micro-controller must finally calculate RS parity coding for the single still CYMK color model JPEG I digitally compressed picture. RS parity coding does error detection and weak error correction at a cost of about 10% extra data. RS(255×8, 223×8) parity coding is the usual mode used for consumer electronics use. The complete digital JPEG I compressed digital photo is stored by the micro-processor/micro-controller over the micro-processor/micro-controller digital computer bus on permanent memory being a y. 2000 removable 56 Mega bytes up to 128 Mega bytes EEPROM memory card (e.g. Smart Memory Card (R), Sans Disk (R), Memory Stick (R) uses a 1 Giga bit/IC single IC) or else an older removable micro-CD kept in a micro-CD drive.

The JPEG I standard digital compression modes are:

a). lossy compression with the discrete cosine transform (JPEG DCT), lossy run length encoding (RLE) which maximizes strings of 0's, and lossless Huffman coding which is a table of bit patterns and a pattern repeat count,

b). lossless JPEG I compression using the arithmetic coding algorithm which produced much larger JPEG I files, or

c). variable format JPEG I compression depending upon input factors for size of picture frame [inches×inches], image resolution [dots per inch], and communications bandwidth [Mega bits/second].

a). Lossy JPEG I compression uses:

1′). a lossy time/position domain conversion to frequency domain transform called the discrete cosine transform (JPEG 8×8 DCT). This conversion is just like a human being doing time domain based music cassette tape conversion into musical notes (frequency domain) without timing bars. Low frequency DCT picture patterns are judged as ‘visually important’ solid blocks of color and are left in, while high frequency picture patterns are judged as ‘visually unimportant’ and therefore lossy compressed out. The discrete cosine transform (JPEG DCT) process is a minor lossy process. JPEG DCT is highly asymmetric meaning the compression time/de-compression time ratio is about 10 to 1.

JPEG 2000 uses fast wavelet compression which has been compared to converting time domain based music cassette tapes into musical notes with timing bars (see below). Only high frequency and short timing picture patterns are judged as ‘visually unimportant’ for lossy removal and compression. This is obviously much more accurate producing much greater compression without loss of picture detail, however, the still highly asymmetric compression process takes much longer over JPEG I.

2′). run-length encoding (RLE) is done by simply counting long strings of ‘0's.’ However, on high frequency components sorting by the DCT algorithm used to judge ‘visually unimportant’ picture pattern areas (low frequency picture patterns are left in as being judged ‘visually important’), a lossy process is done which simply drops out ‘1's’ in long strings of ‘0's’ to maximize RLE ‘0’ string counts. DCT sorted low frequencies are judged as “visually unimportant areas” which should have all data retained.

3′). Lossless Huffman coding? which is the storage of tables of bit patterns by index to the bit pattern and bit pattern repeat count.

b). A second JPEG I format supports lossless compression. The lossless arithmetic coding algorithm is used.

c). A third JPEG I format supports lossy compression with variable bandwidth parameters and variable loss parameters for different picture frame sizes [inches×inches], various resolutions [dots per inch], and for various communications bandwidth [Mega bits/second] availability.

JPEG 2000 is a newer standard for fast wavelet compression.

Fast wavelet compression converts the position/time domain audio/video analog signal into a (frequency, time) domain digital signal. This is just like a human being doing music audio tape conversion to musical notes with timing bars. The very low frequency and brief time “video elements” may be classified as “visually unimportant” and lossy compressed out without significantly effecting the overall picture quality. This is just like compressing musical notes with timing bars in which low frequency notes with brief timing are dropped out of the music. The introduction of the “timing bars” makes the technique more efficient in terms of compression than original JPEG. However, the fast wavelet compression technique is very asymmetric being computationally intensive to compress although much faster to de-compress than original JPEG I.

The JPEG I digitally compressed image is shuffled by the micro-processor/micro-controller back over the bus to the DRAM.

8). A permanent memory device stores the JPEG I compressed digital photo to replace the older photographic chemical emulsion camera film. The micro-processor/micro-controller shuffles the digitally compressed JPEG I image (already having been ‘squished’ or typically lossy mode digitally compressed by the JPEG I firmware algorithm) from the DRAM over the micro-processor/micro-controller bus and permanently stores it in the removable, permanent memory cards along with RS parity coding for error detection and weak error correction. The memory cards are made out of banked electrically erasable programmable read only memory (banked EEPROM) integrated circuits placed upon insertable memory cards. In y. 2002, insertable memory cards with banks of older electrically erasable programmable read only memory (EEPROM banks) in 32 Mega bytes/card up to 128 mega bytes/card (e.g. Smart Memory Card (R), Sans Disk (R), Intel FLASH (R)). A single latest generation, large capacity integrated circuit (IC) of electrically erasable programmable read only memory (EEPROM) comes in 128 Mega bytes/IC or 1 Giga bits/IC (e.g. Memory Stick (R) consortium).

9). A power supply such as a nickel cadmium (NiCad) battery which is in unit re-chargable by transformer and wall AC plug. Lithium batteries hold more current for portable digital camera use, but, are re-chargable only with an external bulky recharging pack.

10). An external personal computer (PC) cable is supported to transfer the JPEG I compressed digital photo to a PC having a cable input such as Universal Serial Bus (USB) which supports up to 3 Mega bit/second data transfers for a maximum of 6 feet.

The much faster Institute of Electrical and Electronic Engineers (IEEE) 1394 (“Firewire”) standard supports a much faster 10-100 Mega bits/second serial data transfer at distances up to 11 feet. In y. 2002, the PC needs a mother-board provided usually in addition to up to four USB serial bus interfaces, or else a PCI I/O bus IEEE 1394 circuitry (one IEEE 1394 integrated circuit) plus interface. This IEEE 1394 interface transfers the permanently stored camera data at a much faster rate to a personal computer (PC) for printing on an ink-jet printer with special paper. Some newer ink jet printers with camera ‘docking ports’ will directly read the internal memory from the digital camera. Alternately, some newer ink jet printers have a Memory Stick (R) interface such that a Memory Stick unit (single IC EEPROM) can be directly removed from the digital camera with digital photo's and then stuck into the ink-jet printer for printing.

IEEE 1394 (“Firewire”) with special 4-pin or 8-pin IEEE 1394 connectors constitutes the Sony VAIO (R) cable. The Sony VAIO (R) video camera needs a special Sony VAIO (R)personal computer (PC) with a VAIO Sony (R) cable which consists of a “Firewire” cable (IEEE 1394) along with the IEEE 1394 connector. The Sony VAIO computer comes standard with a IEEE 1394 built-in PC motherboard circuitry with the IEEE 1394 connectors. A standard non-VAIO PC with a IEEE 1394 interface and IEEE 1394 cable can be used directly with a Sony VAIO (R) video camera through a IEEE 1394 connector on the video camera. Sony VAIO (R) is designed to be a whole family of integrated and compatible digital consumer hardware and software products system integrated together by VAIO cables for “hot disconnect,” or “hot plug n' play” on the go fast configuration and transfer of digital audio/video without hardware and software glitches from re-configuration which plagued older systems.

Emerging Bluetooth radio frequency (RF) or wireless connections can connect a still digital camera to a PC without use of a cable, but, with a 2.4 Giga Hertz antenna which attaches by cable to the single Bluetooth integrated circuit (IC) on the mother-board. Bluetooth maximum bandwidth is 1 Mega bits/second for a maximum range of 30 feet. The low data rate and low cost of US $5/IC is useful for transferring already stored and digitally compressed JPEG photographs only.

### Prior Art of Digital Audio/Video Movie Cameras

A digital audio/video movie camera consists of the same parts listed above for the digital photographic still camera. Some additional features not necessary in still photographic cameras are listed:

1). A video camera lens as described above for still cameras, but, usually of much lower optical quality,

2). A video camera body of plastic and or steel,

3). Active infrared (IR) auto-focus video cameras use infrared (IR) transmitters or infrared (IR) diodes to reflect with body heat off of a still or moving warm body suspect resulting in a ‘red infra-red spot’ on a combined infrared/visible light CCD.

4). The reflected heat is collected by a combined infrared/visible light frequency charge coupled device (CCD). In y. 2002, the video camera's CCD is in the resolution of 1-2 Mega pixels/CCD, much lower than a still JPEG digital camera's resolution of 3-6 Mega pixel/CCD given that the frame rate is 20-40 frames/second where 30 frames/second progressive (all lines per frame) is real-time video. An 800 column×600 row frame is 480,000 pixels. Only the strongest source of moving heat image will give the (x, y) point of interest of the infrared heat image (x,y) used for “passive auto-focus” of the visible light image or in other words fine image contrast at point (x,y) focusing using a servo-motor controlled lens. The color digital processing uses the latest and most accurate color capture ‘color grey scale’ use of ‘True Color’ mode of 10-bits red, 10-bits green, 10-bits blue or 32-bits/pixel or 4 bytes/pixel (RGB color model) per digital color/pixel which is converted to MPEG X Yellow (Y) Cobalt blue (Cb) Chromium red (Cr) (YCbCr color model) and digitally compressed with an average 8 to 1 MPEG X compression ratio (less with action moving shots), plus about 10% extra Reed Solomon parity coding error detection and weak error correction bits are added. RS(255×8,223×8) is typically used in consumer electronics which adds about 10% extra bits. An 800×600 pixel frame at 30 frames/second progressive scanning rate (all rows/frame) plus a 2-channel stereo compressed digital audio stream of 24 bits/sample at a 44 Kilo Hertz sampling rate plus about 10% RS parity coding will give an audio/video MPEG X data stream of about 5-10 Mega bits/second or ⅝-1.25 Mega bytes/second. Typical MPEG IV compressed digital streams are from 3 Mega bits/second up to 10 Mega bits/second for high action sports filming.

The infrared (IR) imaging of the IR/visible light frequency CCD can be used without night lighting to collect night heat images of moving suspects even with no background lighting. This mode cannot be used for suspect identification, but, will reveal suspect criminal activity.

5). A separate integrated circuit (IC), the complex analog to digital converter (ADC), is needed to take the real-time movie frames of analog RGB video signal (analog black and white NTSC-like signal for each color layer) from the one to three CCD's depending upon use of Bayer filtering. The ADC does non-linear pulse code modulation (PCM) converting the analog RGB signals to digital R′G′B′. The digital R′G′B′ signal is non-linear in modern use because it is gamma adjusted which allows for greater signal loss at higher frequencies (towards the red end of the visible light spectrum) giving a larger intensity at higher frequencies over a comparable linear intensity value. A single color of (digital RGB/MPEG X macro-blocks of a single frame) video signal is collected in the ADC's output FIFO latch and are ready for DMA transfer over the digital micro-processor/micro-controller bus to the either dedicated MPEG X integrated circuit (IC) or the MPEG circuitry included as a 'silicon compiler’ function inside of a mixed circuit IC. Firmware MPEG X algorithms are too slow for camcorder use.

6). The digital RGB signal may be modulated to analog (analog R′G′B′ with the hyphen indicating gamma adjustment or non-linearity of higher frequencies) for output to a small, flip-out, built-in video camera liquid crystal display (LCD) monitor. This LCD monitor displays a non-mirror-image and positive image which may supplement a through the glass view-finder in a digital camcorder.

The ADC read-out over the micro-processor/micro-controller digital data bus to the MPEG X chip does the ‘electronic mirror function.’ A row and column bit reversal is needed to both mirror-image invert and upside-down invert the CCD captured image already having unavoidable optical lens effects such that the image becomes non-mirror-image and rightside-up. MPEG X and the LCD display both need a non-mirror image and rightside-up image.

7). A dedicated MPEG X integrated circuit (IC) or else a ‘silicon compiler’ MPEG X circuitry group inside of a single modern mixed signal IC receives the MPEG X macro-block group of video rows of digital RGB for a single MPEG X video frame. A simplest MPEG X self-contained intra-frame (with-in one frame) processing is examined just below for example simple processing flows.

The hardware based MPEG X circuitry must do very high rate floating point ‘color matrix transform’ conversion of the digital RGB color model/MPEG X macro-block rows of a single frame into MPEG X's digital Yellow (Y), Cobalt Blue (Cb), Chromium Red (Cr) or digital YCbCr color model/MPEG X macro-block rows of a single frame of a digital movie. Color-matrix transform requires the macro-block groups of rows for all digital RGB colors to be available at once, but, not the entire frame in all separate digital RGB colors. Color-matrix transform is simply a (x, y, z)=f(x′, y′, z′) fast floating point register conversion. Gamma correction is planned color compensation for the non-linearity of reproducing higher frequency colors which is a floating point correction of the 3-axis color value. After color-matrix transform for a MPEG X macro-block group of rows, the MPEG X circuitry does digital compression on the macro-block rows/single frame using the hardware MPEG X discrete cosine transform (DCT) in a time domain to frequency domain transform. This is likened to converting a musical time domain based tape recording into frequency domain based music notes without the help of timing bars. The high frequency video components indicate ‘visually unimportant’ areas which may be lossy compressed out without huge losses of visual detail.

Different MPEG X macro-block arrangements or groups of rows/picture frame are allowed under MPEG IV specification of the YCbCr color model. Color densities for (Yellow, Cobalt Blue (Cb), Chromium Red (Cr)) (e.g. (4, 1, 1), (4, 2, 2,), (4, 4, 4)) for a standard 8×8 hardware discrete cosine transform (8×8 DCT) which give different color densities of Yellow vs. Cobalt Blue (Cb) vs. Chromium Red (Cr) which are tailored for different user applications which may need more color detail and also take up much more video tape capacity. Macro-block pattern (4, 1, 1) produces the least digital data so is useful for home digital movies. Macro-block pattern (4, 4, 4) would be useful for professional movie filming where the highest color reproduction and color calibration is desired. MPEG X 8×8 discrete cosine transform (MPEG 8×8 DCT) is not compatible with JPEG I 8×8 discrete cosine transform (JPEG I 8×8 DCT) and is not compatible with DV (R) video's discrete cosine transform's (DV (R) 8×8 DCT or else 4×8 DCT).

The MPEG X digitally compressed output macro-block groups of rows/single movie frame are collected in a first in first out (FIFO) buffer for DMA transfer over the micro-processor/micro-controller bus to the DRAM or faster SDRAM. A MPEG X ‘presentation time stamp (PTS)’ or n-bit digital stamp is periodically added in at intervals no less than 700 milli-seconds (7/10^{ths} of a second) to various MPEG X streams to correlate the different MPEG X digital data streams such as:

control stream,

video stream (presentation time stamped (PTS'd)),

with user data stream extensions such as tele-text, closed captioning for the hearing impaired, GPS satellite navigation data (uncorrelated with video), interactive television guide data, annotation data under a MPEG VII standard format,

audio stream (presentation time stamped (PTS'd)),

for replay with use of a target system hardware clock called a MPEG X play-back hardware digital timer ‘system time clock (STC),’ which is originally initialized to a digital time value in the initial MPEG X control stream called the ‘program clock reference (PCR).’ A play-back computer checks the ‘presentation time stamp (PTS)’ values with the current value of the original ‘program clock reference (PCR)’ initialized hardware time value about once a second. Re-synchronization can be done with skipping MPEG X frames or very minor speeding up or slowing down play-back speeds. The goal is to keep the replay frames as even as possible due to human eye sensitivity to ‘irregular motion jerk’ vs. ‘smooth and continuous motion.’

The MPEG X circuitry also does MPEG X audio stream digital compression after inputting a 2-channel microphone produced time domain based digital audio stream from the audio 2-channel very low sampling rate analog to digital converter (ADC). The digitized time-domain audio data is collected in the DRAM. The MPEG X circuitry (dedicated IC or mixed signal IC) reads the DRAM data, does time domain to frequency domain audio transform, and then does the digital audio compression technique of ‘audio perceptual shaping.’ This audio technique basically identifies high frequency and low amplitude ‘foreground sound’ which is concurrent and normally almost completely ‘drowned out’ by low frequency and high amplitude ‘background sound’ and lossy compresses out the ‘foreground sound.’ MPEG I audio layer 3 was shortened to the acronym (MP3) and used as a separate audio only standard just for digitally compressed music.

In y. 2003, MPEG I audio layer 3 (MP3) as an audio compression standard is ten years old and quickly being replaced by more efficient and ‘better sounding’ digital audio compression algorithms (e.g. Fast Wavelet Compression (R) Corporation, Advanced Audio CODEC (R) (AAC (R))) which convert the time domain into both a (frequency domain note, time of frequency note) transform which has been likened to a time-domain music audio tape converted into a frequency based bar chart for music plus timing bars. The selection of ‘foreground sound (defined just above)’ masked out by concurrent ‘background sound (defined just above)’ becomes much more selective due to the (frequency note, time of frequency note) information vs. (frequency) alone information. A MPEG X ‘presentation time stamp (PTS)’ or n-bit digital stamp periodically placed at intervals no less than 700 milli-seconds (7/10^{th} of a second) in the data correlates data for replay with use of a re-play system hardware clock called a ‘system time clock (STC)’ which is initialized with an initial MPEG X control stream value called the ‘program clock reference (PCR).’ All MPEG X separate digital streams have a periodic PTS in a ‘digital streams’ philosophy.

A Movie Picture's Expert's Group IV (MPEG IV) compression integrated circuit (IC) takes the completed macro-block row of non-mirror image and rightside up (row and column bit reversed), uncompressed digital red, green, blue or digital RGB color model image frame output from the analog to digital converter (ADC) attached to the charge coupled device (CCD) and converts it with color matrix transform circuitry to MPEG X's digital yellow (Y), cobalt blue (Cb), and chromium red (Cr) or digital YCbCr color model. The MPEG IV's discrete cosine transform (DCT) circuitry digitally compresses the macro-block group of rows/picture frame data using lossy compression. Digital video compression greatly reduces the data rate for a 480 line viewable screen from 27 Mega bytes/second down to 3-10 Mega bits/second. The MPEG X circuitry adds error detection and weak error correction RS parity bits (typically Reed Solomon coding) which adds about 10% to the data bits.

MPEG IV standard based digital lossy compression is done with several internationally patented techniques assembled into a “patent pool” which were combined into the MPEG I, II, and IV standards by the MPEG standards committee. Many MPEG I and MPEG II patents were from the completely software based Apple (R) computer Quick-Time (R) movie standard for personal computers.

MPEG IV basically uses intra-pictures (I-pictures) also known informally as independent pictures, predicted pictures (P-pictures), and in-between pictures (B-pictures). The P-pictures use motion projection algorithms from an I-picture. The B-pictures use interpolation techniques between a single I-picture and another I-picture or a P-picture. The I-pictures are independent from any other I-picture, P-picture, or B-picture.

The I-pictures use the MPEG IV compression techniques of:

a). a lossy time/position domain conversion to frequency domain transform called.the discrete cosine transform (DCT). A standard 8×8 DCT transform is used upon a single macro-block which is a group of four 8×8 basic blocks with each basic block being eight rows by eight columns as in the Yellow (Y) color layer. This same Yellow (Y) color layer will have a matching ¼ color density Cobalt Blue (Cb) color layer with only one 8×8 basic block. This same Yellow (Y) color layer will have a matching ¼ color density Chromium Red (Cr) color layer with only one 8×8 basic block. The sum of the YCbCr color model is called a (4, 1, 1) macro-block configuration. Yellow is emphasized because it registers very poorly in the human retinal sensors. Other macro-block configurations are defined by the MPEG X specification for use with greater communications bandwidths and for richer color detail in the Cobalt Blue (Cb) and Chromium Red (Cr) color layers. This DCT conversion from the time domain to the frequency domain is just like a human being doing time domain based music tape conversion into musical notes (frequencies) without timing bars.

b). run-length encoding (RLE) on high frequency DCT components which selects “visually unimportant areas” to do lossy compression by maximizing strings of 0's by altering 1's to 0's then storage of locations and counts of strings of 0's, and lastly

c). lossless Huffman coding which is the index to a storage table of unique bit patterns by bit pattern repeat count.

Discrete cosine transform (DCT) algorithms for time domain to frequency domain transform are in y. 2003 a decade old. Audio/video standards for fast wavelet compression as used in JPEG 2000 (R), or Fast Wavelet Compression (R) are now in proprietary format. Advanced Audio CODEC (AAC (R)) is an audio only fast wavelet compression technique which is one decade beyond MPEG I Audio Layer 3 (MP3) format. Fast wavelet compression converts the position/time domain into a (frequency, time) domain. This is just like a human being doing music audio tape conversion to musical notes with timing bars. The very high frequency and brief time “video elements” may be classified as “visually unimportant” and lossy compressed out without significantly effecting the overall picture quality. This is just like compressing musical notes with timing bars in which high frequency of occurrence notes (frequencies) with brief timing indicated by timing bars are dropped out of the music. The introduction of the “timing bars” makes the technique more efficient in terms of compression than original JPEG. However, the technique is very asymmetric (about 20 to 1) being computationally intensive to compress although much faster to de-compress than original JPEG. Commercially distributed music can be factory digitally compressed, so, compression time is not a major concern. Digital de-compression speed is of concern with low rate digitally compressed music using firmware based digital signal processors. Digital de-compression of fast wavelet audio/video commercial movies will require a custom fast wavelet silicon compiler function to a mixed signal integrated circuit (mixed signal IC).

Audio data is integrated into the MPEG X video using periodically placed at no less than 700 milli-second intervals “presentation time-stamps (PTS).” The audio stream is defined by a separate audio layer (e.g. MPEG I audio layer 3 which was shortened into the MP3 music file name). The re-play MPEG X computer uses a digital hardware timer which is initialized with the ‘program clock reference (PCR)’ from the initial MPEG X control stream. Thereafter, the “system time clock (STC)” or system hardware digital clock is used to correlate the separate and fully independent video data stream and audio data stream for play back by occasionally skipping frames or speeding up and slowing down play back rates. Audio compression uses a number of lossy compression techniques the most important being ‘audio perceptual shaping.’ ‘Audio perceptual shaping’ gets rid of detailed high frequency and after that low amplitude ‘foreground sound’ which is concurrent with low frequency and after that high amplitude ‘background sound’ with the ‘background sound’ usually drowning out the ‘foreground sound.’ Digital audio compression greatly reduces very low quality digital bandwidth from 56 Kilo bits/second/channel (8 bits/sample at a 8 Kilo Hertz sampling rate) down to 20 Kilo bits/second/channel. Digital concert quality sound for older compact disks (CD's) were originally recorded at an uncompressed, 16 bits/sample at a 20 Kilo Hertz sampling rate (320 Kilo bits/second/channel plus 10% more for RS error correction/detection parity codes). Modern y. 2000 digital concert quality sound for digital versatile disks (DVD's) is recorded at a 24 bits/sample at a 44 Kilo Hertz sampling rate (956 Kilo bits/second/channel plus 10% more for RS error correction/detection codes). Good quality MP3 sound comparable to an FM station on a clear day can be recorded at a compressed digital rate of 56 Kilo bits/second plus 10% for RS error detection and correction parity coding.

8). The micro-processor/micro-controller bus connected synchronous dynamic random access memory (SDRAM) collects the MPEG X video frames in the MPEG X digital compressed video stream and also the MPEG X digitally compressed audio stream. The micro-processor/micro-controller must collect this SDRAM data over the micro-processor/micro-controller digital data bus for MPEG X final ‘control stream’ packaging with the addition of any ‘user data extensions’ to either the ‘MPEG X audio steam’ or ‘MPEG X video stream’ as in MPEG VII annotation codes or teletext, closed captions for the hearing impaired, or 2-way interactive television/cable guide programming.

9). A much more powerful computer on a chip or micro-processor/micro-controller than what is used in a still digital JPEG I still photo camera is employed for byte-shuffling and for MPEG X digital packaging of the final audio/video stream. The MPEG X audio/video MPEG X compressed digital frame video plus audio separate digital data stream assembly using a ‘MPEG X control stream’ which must be recorded to mini-DV (R) or DV (R) fully digital audio/video tape (replacing older helical scanning technology analog Hi-8 (R) 8 mm analog video-tape).

A micro-processor/micro-controller is a computer's central processing unit (CPU) combined with integrated circuitry and built-in temporary computer program only memory (SRAM) and permanent computer program memory (banked-EEPROM) needed to do input/output (I/O) on a computer bus based system. The micro-processor/micro-controller is needed to shuffle the audio/video digital data from chip to chip over the micro-processor/micro-controller input/output (I/O) bus. The micro-processor/micro-controller gets a row and column bit reversed image from the ADC to give it a non-mirror image and rightside-up image for both the LCD display and also for MPEG X video signals.

10). A permanent memory device stores the MPEG X video to replace the older photographic movie film. Commercial video-camera camcorder videotape in y. 2002 is fully digital using mini-DV (R) format. A higher resolution and wider and longer tape is also supported in a standard called Digital Video (DV) which is aimed at professional videotaping equipment. However, Mini-DV or DV (R) digital tape was not developed for MPEG IV video cameras. DV (R) compressed digital audio/video format was originally developed as an entirely separate competing commercial Consumer Electronics Industry Association (EIA) standard for digital compressed video to compete with MPEG X. The DV (R) digital video standard uses intra-frames only, the discrete cosine transform (DCT) standard computed for two adjacent ‘fields’ which are odd and even rows of ‘DV macro-blocks’ within the same frame, run length encoding (RLE), and Huffman coding, but, it not compatible with any MPEG X standard. Both a 8×8 DCT transform is used for little motion frames shown in two adjacent frames being almost the same, and a 4×8 DCT transform is used for high motion frames shown as two adjacent frames being radically different. Different macro-block arrangements are supported such as (Yellow, Cobalt Blue (Cb), Chromium Red (Cr)) by 8×8 basic block count which corresponds to color density: (2:1:1), (4:1:1) for different communications band-widths and color density detail needs. DV (R) video has limited screen formats with the basic one being a 480 viewable line (a second 576 viewable line format is also supported), compressed digital format meant for digital to analog audio/video conversion for customer viewing on 487 viewable line analog NTSC televisions. DV (R) video used in PC's must be digitally converted using library tools into the more conventional MPEG X video for use of the popular MPEG X personal computer (PC) video editing software.

11). The digital RGB signal may be modulated to analog (analog R′G′B′ with the hyphen indicating gamma adjustment or non-linearity of higher frequencies) for output to a small, flip-out, built-in video camera liquid crystal display (LCD) monitor.

12). An external personal computer (PC) cable is supported to transfer the JPEG compressed digital photo to a PC having a cable input such as Universal Serial Bus (USB) with USB connectors and interface circuitry on both ends which supports up to 3 Mega bit/second data transfers for a maximum of less than 6 feet.

The much faster Institute of Electrical and Electronic Engineers (IEEE) 1394 (“Firewire”) standard for interface circuitry and cables supports a much faster 10-100 Mega bits/second serial data transfer at distances up to 11 feet.

IEEE 1394 (“Firewire”) with special connectors called IEEE 1394 4-pin and 8-pin connectors constitutes the Sony VAIO cable which needs a special Sony VAIO personal computer (PC) which is designed to be a whole family of digital consumer products which are hardware and software systems integrated together for fast transfer and hardware glitch and software glitch minimized “hot connect/disconnect transfer” of digital audio/video over the VAIO cables.

Emerging Bluetooth radio frequency (RF) or wireless connections can connect a still digital camera to a PC without use of a cable, but, with a PCI bus plug-in card with a 2.4 Giga Hertz antenna. Bluetooth maximum bandwidth is 1 Mega bits/second for a maximum range of 30 feet. The low data rate and low cost of US $5/IC is useful for transferring already stored and digitally compressed JPEG photographs only.

Wireless video cameras (e.g. X10 (R)) use IEEE 802.11b and IEEE 802.11c Wireless Ethernet or wireless connections to transmit a “live broadcast” video camera to a PC. IEEE 802.11b maximum bandwidth is 10 Mega bits/second and IEEE 802.11c maximum bandwidth is 100 Mega bits/second.

### Prior Art of Hybrid MPEG IV/JPEG Audio/Video/Still Cameras

In y. 2002 the use of hybrid design in prior art has occurred for a commercial JVC (R) Corporation, low-end, audio/video camera which takes either/or JPEG still photographs or else MPEG IV audio/video, but, not both at the same time. The low resolution JPEG still photographs are permanently stored in a removable banked EEPROM or single large capacity EEPROM (e.g. 128 Mega bytes/IC) memory card. The MPEG moving audio/video photographs are permanently stored as compressed digital signals upon DV (R) digital video tape cassettes or mini-DV (R) mini digital video tape cassettes (without use of the competing Digital Video (R) compressed digital audio/video standard). This either/or MPEG IV audio/video compressed digital or else but not both JPEG I video still picture compressed digital output signal comes from a special JVC (R) Corp. single CCD camcorder system with a special micro-coded JVC MPEG IV integrated circuit (IC) which does appropriate digital RGB color model to either MPEG IV's YCbCr color model or else JPEG I's CYMK color model. The difference in color models from MPEG IV's YCbCr to JPEG I's CYMK is handled by different numbers of color video ‘streams’ or ‘layers.’ The hybrid chip then does micro-coded loads of different constant table values for the unique differences of the basic 8×8 and 4×8 discrete cosine transform (DCT) mathematical function used by both MPEG IV and JPEG (R video formats. The appropriate digital compression standard is done in the frequency domain. The hybrid chip does RS parity coding. This JVC (R) standard is not the same as ‘motion JPEG I’ which is not MPEG X compatible. The JVC (R) Corp. CCD systems used in the exclusive MPEG IV format uses only intra-pictures (I-pictures) and no predicted pictures (P-pictures) and no between pictures (B-pictures). This JVC MPEG IV CCD system produces a high data rate of 3 Mega byte/second (about 24 Mega bits/second) of MPEG IV signal which is 8 times higher in bandwidth than the normal 3-10 Mega bits/second MPEG IV signal. This is due to the absence of motion compensation done in the predicted (P-pictures) and between (B-pictures). The JVC MPEG IV CCD system's goal is to make the MPEG IV I-pictures as close as possible to the JPEG I still photographs in lossy compression mode by using a micro-coded single-mode MPEG IV/JPEG CCD system with micro-coded on-chip table loaded values for the 8×8 discrete cosine transform (DCT) compression/ decompression differences. The JPEG I still photos have low resolution compared to a 6 Mega pixel digital still camera due to the low resolution full-motion video CCD, but, the system offers an alternative fully digital camcorder mode at the same price.

### Prior Art of Charge Coupled Device (CCD) Details

Charge coupled devices (CCD's) have certain solid state, fabrication details which will optimize them for certain applications:

1). resolution [pixels/CCD].

In y. 2002, a 6 Mega pixel non-Bayer filtered CCD has about 3,000 Dots Per Inch (DPI) on a standard 4″×6″ snap-shot which cannot compare to chemical emulsion photographic film with 1 micron silver halide molecules or about 25,000 Dots Per Inch (DPI) in the same 4″×6″ snap-shot. The advantage of photographic emulsion is that the resolution does not decrease with larger emulsion sizes, unlike digital enlargement (‘digital enhancement’ or ‘digital zoom’) which must ‘stretch out’ a fixed resolution from a CCD without adding new visual information. Digital interpolation is sometimes done which adds ‘phony’ interpolated image lines in every other line (this was common on enlarging analog NTSC signals up for big-screen televisions). Bayer filtering reduces the stated resolution by a minimum of a division by 3, with slightly more due to ‘borderline odd edge effects’ from a RGB Bayer cluster being split down an unfortunately placed horizontal or vertical image line. This effect can be detected in the LCD image with a slight user movement usually getting rid of it in a central image area and possibly introducing new ‘border jaggy effects’ elsewhere. A three CCD camera is the only purist solution.

2). light frequencies captured such as visible light frequencies, infrared (IR) light frequencies, or combined infrared/visible light frequencies.

An optical filter must be used to break up white light into color components. A Bayer filter is a semi-conductor process to place tiny red, green, and blue filters upon a semi-conductor deposition layer.

Infrared light is captured by visible light/infrared light CCD'S.

3). minimum image brightness or luminance [lamberts].

4). minimum image exposure time [lamberts] (important for still or moving images). The exposure time for CCD's is much less than a comparable exposure time or light sensitivity [lamberts] of photographic film. CCD's are now preferred for astronomical viewing and digital recording at all levels due to this advantage.

5). Bayer filtering or RGB cluster filtering for RGB color from one CCD.

Bayer filtering is a semi-conductor process which introduces a semi-conductor deposition layer which forms tiny optical visible white light filters for a cluster of red, green, and blue optical filters. The Bayer filtering process introduces interpolation errors shown as ‘border jaggies’ when an object border in any direction with the worst border effect in the horizontal or vertical direction with the border by chance imaging down the middle of a series of Bayer filter clusters. Bayer filtered systems use only one unit of CCD for red, green, and blue (RGB color model) instead of three units of CCD's with one CCD for red, one CCD for green, and one CCD for blue (RGB color model) for a much lower cost for the expensive CCD component of total cost. Lower resolution occurs for a Bayer filtered CCD over a three unit CCD system.

6). three separate monochrome light CCD's for one red CCD, one green CCD, and one blue CCD.

Expensive commercial digital movie cameras costing discount over y. 2002 US $2,000 per camera unit use three unit CCD systems for much higher resolution and color quality from no ‘border jaggies.

7). passive auto-focusing using auto-focus lens image contrasts on the CCD.

Older passive auto-focus cameras used column contrast analog sampling. Newer passive auto-focus cameras use column and row contrast analog sampling.

8). non-passive auto-focusing using warm blooded hand and warm blooded eye or remote human hand and remote human eye lens focusing.

9). Color blooming effects or the “flower-like artifacts” occur from photons hitting buckets during bucket transfer of a photograph out of the CCD. Closing the shutter button activated shutter curtain over the CCD minimizes this effect. The LCD image can always be checked for ‘color blooming effects’ before permanent memory storage of the photograph from temporary DRAM memory to memory card (EEPROM).

10). Streaking effects or the “lightning like artifacts” from photons hitting buckets during bucket transfer of a photograph or frame out of the CCD.

11). Quantum efficiency or the fact that photons of higher frequencies of light have more energy and produce more electrons in CCD buckets. Use of one dedicated CCD for red, one CCD for green, and one CCD for blue allows use of narrow frequency band optical colored filters for each CCD which greatly reduces quantum efficiency problems. Bayer filtering or semi-conductor thin film RGB filter processing on one CCD does not allow optical filter use.

12). Column contrast, row contrast, and column and row contrast are used in passive auto-focus visible light and infrared light CCD cameras for automatic focus modes.

### IV). PURPOSE/REQUIREMENTS

A). A purpose of the invention in the preferred embodiment is to get rid of fuzzy frame buffer suspect ID photo's obtained from analog, NTSC security video cameras. It will also offer improved suspect photos over all digital compressed Digital Video (DV) video cameras which use DV (R) protocol digital compression, a non-MPEG compatible form of digital compression. It will also offer improved suspect photos over all digital compressed MPEG IV (R) video cameras recording to mini-DV (R) tape.

B). A purpose of the invention in the preferred embodiment is to reduce problem of grainy film wear using analog, NTSC security video signals on Dupont Mylar (R) film based 8 mm or Hi-8 mm video tape. Often even 10 overwrites of analog security video signals on brand new video tape produces graininess through hysteresis or magnetic field wear out which is also called magnetic coercivity.

C). A purpose of the invention in the preferred embodiment is to support fully digital recording over the video local area network (video-LAN) to digital tape drives. Digital tape drives use up/down recording tape instead of the older analog helical scanning VHS tape. Newer after y. 1999 digital video cameras use larger format intended for commercial filming use, Digital Video (DV (R)) compressed digital color audio/video signals which can be de-compressed into digital data for 480 viewable line digital signals. The DV (R) video signals can be stored upon digital magnetic tape through the use of an industry standard commercial format called mini-DV (R) which records upon mini-DV (R) video tape, or else upon wider format, and longer length, digital video DV (R) tape meant for commercial television and movie recording. These all digital formats are much less susceptible to film wear out from hysteresis (magnetic coercivity).

The older analog signal helical scanning video tape technology of analog signal video recording is replaced by up/down recording computer digital tape recording technology of much more robust and compact up and down magnetic bars of computer binary 1's and 0's for much greater video storage per foot of video tape. The mini-DV (R) tape cartridges introduced commercially after y. 1999 was much thinner and smaller than a comparable in recording time and video quality, analog National Television Standards Committee (NTSC) signal which was stored upon the much older Hi-8 (R) (8 mm) tape cartridge.

The invention will support the use of computer industry digital streaming tape drives with removable tape cartridges. In y. 2002, 300 Giga byte streaming tape cartridges are commercially used with 8 Mega byte/second per tape drive recording rates. A 300 Giga byte streaming tape cartridge will store 100,000 seconds of a very high data rate for motion recording MPEG IV format recording at a recording rate of 3 Mega bytes/second or 27 hours of full motion 30 frame/second audio/video.

The invention will support the use of digital versatile disk read/write (DVD-RW or DVD+RW) video recording. In y. 2002, single sided and single density DVD's have 7 times the capacity of a compact disk (CD) or seven×700 Mega bytes/CD for 4.9 Giga bytes/DVD. Double sided and double density DVD's can store four times 4.9 Giga bytes or this amount or 19.6 Giga bytes of data (at a single channel audio/video MPEG IV recording rate of 3 Mega bytes/second this will store about 6.5 thousand seconds or 1.8 hours of full motion recording at 30 frames/second which can be extended to 54 hours at a two frame/second freeze frame recording rate) A y. 1999 DVD is equivalent to a 24×CD in sustained data transfer rate or about 3.4 Mega bytes/second.

D). A purpose of the invention in the preferred embodiment is to support the use of a video camera connection to fully digital video local area networks (video-LAN's) using broadband cable modems (physical cable used as a straight line bus but logically looped and terminated channels which offer up to a maximum of 1 Giga bits/second digital bandwidth now available in y. 2002). Support future use of single mode (1 Giga bit/second digital bandwidth now available) and multi-mode fiber optic cable medium (100 Giga bit/second digital bandwidth now available). Fiber bus or star topologies supported with the star topologies using fast switching hubs much less vulnerable to vandalism or criminal sabotage (criminals may try to rip a bus based video camera out to sabotage the whole video system). This will replace current security video camera widespread use of closed circuit television (CCTV) analog, coaxial cable (which has a maximum total analog capacity of 400 Mega Hertz and a digital capacity of 1 Giga bits/second). In cable station use, a single 6 Mega Hertz wide analog cable video channel is usually converted into a 30 Mega bits/second (downstream to the customer) and 2.4 Mega bits/second (back to the cable station or cable head-end) shared by up to 30 homes per cable loop. The digital broadband capacity is used for digital cable modems at homes and businesses which must be shared or bandwidth divided by 1 up to 30 users per cable loop. The maximum digital broadband or multi-frequency capacity of the coaxial cable is about 1.0 Giga bits/second now supported by several broadband cable modem chip vendors on the cable head-end only for all digital cable systems.

E). A purpose of the invention in the preferred embodiment is to support the use of a video local area network (video-LAN) connected digital display device used as a very interactive and highly intuitive, man machine interface (MMI) specifically designed for mobile driver/pilot control use called a ‘no-zone electronic rear view mirror (nz-mirror)’ which gives enhanced eye-mind intuitive orientation and mental coordination for a fast response [REF 504, 512]. This is like the cross of a digital video game with a digital television with GPS satellite navigation and a communications channel giving very flexible, user selectable, real-time video displays which are digitally frame merged and digitally sequenced.

In mobile platform use, the digital display device with a computer and some form of communications channel is called a ‘video telematics’ video computer having integrated GPS satellite navigation receiver data, many communications channels, and integrated video channels for display. The very specialized digital video camera of this invention was originally designed as an add-in device for use in this system.

F). A purpose of the invention in the preferred embodiment is to support the completely unattended security, video camera function of “electronic pan and tilt” which does not require a “warm blooded” human operator to mechanically “pan and tilt” move or even a remote human operator using a joy-stick control to servo-motor “pan and tilt” a remote video camera. The “electronic pan and tilt” is an electronic focus mode involving no mechanical digital video camera action which enhances a prior art passively focused charge coupled device (CCD). A passively focused charge coupled device (CCD) is prior art electronic contrast focused using a CCD with servo-feedback circuit to control mini-adjustments to a wide angled lens (this mimics a warm blooded human hand or remote human camera operator doing fine lens adjustments for final focus upon a subject based upon his own brain's contrast readings). The invention's technology is meant for very high reliability, fully unattended, security video camera use with wide-angled lenses, fixed camera position (no warm blooded operator or remote mechanical pan and tilt).

G).A purpose of the invention in the preferred embodiment is to use smart video cameras which allow non-human operator optical zoom and optical center framing from smart, micro-processor/micro-controller image processing firmware.

H). A purpose of the invention in the preferred embodiment is to get close up, fully digital, Joint Photographer's Experts Group (JPEG I) digitally compressed still photo's of moving suspect's bodies and faces at different camera angles.

I). A purpose of the invention in the preferred embodiment is to get mid-range, simultaneous, high resolution, fully digital Joint Photographer's Experts Group (JPEG I) digitally compressed still photo's of moving suspect's bodies and faces at different camera angles.

J). A purpose of the invention in the preferred embodiment is to produce a hybrid design, integrated, fully digitally compressed, Motion Picture Expert's Group (MPEG IV) video stream with I-Pictures only and no P-Pictures and no B-Pictures to reduce timing slop which includes digital time and date stamps for each and every frame image using a unique non-MPEG X cryptography “silhouette-like technique.” The MPEG IV video will be occasionally interspersed with the much higher resolution JPEG I still photos. This is called the proposed MPEG IV Level S1/E1 Security Video/Entertainment Video format (proposed new MPEG standard with this invention). The traditional MPEG IV video stream and audio stream using ‘MPEG presentation time stamps’ will be supplemented with a very low rate JPEG I high resolution still photo stream also ‘MPEG presentation time stamped’ as well as the introduction of the ‘silhouette technique’ used to add to each and every video frame a specially ‘cut and pasted’ in background area: possible GPS date, GPS time (good to about 1000 nano-seconds), GPS position in latitude, longitude, altitude, GPS delta position in delta latitude, delta longitude, delta altitude, camera channel, user annotation text, possible weather data text, ground terrain map digital data, etc.

The new with this invention proposed MPEG IV Level S1/E1 Security Video/Entertainment video format will support variable parameters which will be supported for customer selected digital bandwidth [bits/second] divided up into resolution [bits/frame]×progressive frame rate [frames/second]. A customer selected interlaced frame rate [½ frames/frame refresh period] will also be supported. Motion studies require greater timing accuracy than standard MPEG IV one-half second timing slop between I-frames at a 3 Mega bit/second standard rate for a 360-line frame. On the other extreme, suspect identification photos require greater frame resolution than standard MPEG IV 483-viewable line frames.

K). A purpose of the invention in the preferred embodiment is to keep micro-processor processed motion control models of several moving suspects at once which will allow sharp focus for sequential still suspect photographs of each, will also allow sharp mid-range still photograph focus upon many moving suspects, and will also allow distance focus if no moving suspects are detected. This is called “electronic pan and tilt.”

L). A purpose of the 1^{st} alternative embodiment is very low cost, fully automated, limited moving suspect tracking, with medium resolution JPEG photographs of only one or two moving suspects.

M). A purpose of the 2^{nd} alternative embodiment of a focal plane array based system is very high cost, fully automated, large number of moving suspect tracking, with very high resolution still JPEG photographs of multiple moving suspects.

### V). BRIEF DESCRIPTION OF THE DRAWINGS

FIG. 1 is a diagram at an unmanned, fully automatic, security installation.

FIG. 2 is a mechanical diagram of a hybrid MPEG X/JPEG X audio/video camera (100) with major components located in the housing.

FIG. 3 is a system's block diagram at a chip level inside the audio/video camera (100).

FIG. 4 is a timing diagram of the new with this invention the new with this invention proposed MPEG X level S1/E1 which does hybrid MPEG IV and simultaneous JPEG data streams.

FIG. 5 is a diagram of the 1^{st} alternative embodiment, medium cost, with a dedicated small cluster of infrared diodes pointing out in all outward directions and a single combined infrared/visible light focal plane array charge coupled device (focal plane CCD) to collect both heat images and visible light images.

FIG. 6 is a diagram of the 2^{nd} alternative embodiment, highest cost, with a dedicated infrared light emitting diode (IR LED) array pointed in many different outward directions and a single, dedicated, infrared/visible light only charge coupled device (hybrid focal plane CCD) used to receive heat images and visible light images, as well as a dedicated advanced reduced instruction set micro-controller (strong ARM micro-controller) to do both computer motion control model and 3-dimensional image modeling on all moving heat image and visible light imaged suspects. A hybrid design with an ultra-sonic sound transmitter and an ultra-sonic receiver with sonar processing is possible.

### VI). REFERENCE NUMERALS

### REFERENCE NUMERALS—ALL EMBODIMENTS

100. hybrid MPEG X/JPEG X security video camera (“bug face”)

101. video camera body made of aluminum or plastic or both (“bug-body”)

102. adjustable low power florescent light (“bug eyes”) or highly directional low amperage arc-lighting for outdoor use

103. stereo 2-channel microphones (“bug-ears”)

104. joint photographer's expert's group (JPEG) optimized infrared/visible light charge coupled device (JPEG CCD),

high resolution for still pictures,

Bayer filtered red, green, blue (RGB) from a single CCD for low cost as opposed to a red CCD, green CCD, and blue CCD,

smart passively focused using visible light image contrast at the motion focal CCD (x, y) point input which is either input from the micro-processor/micro-controller's motion model for many moving suspects or else uses the strongest infrared light heat image (x, y) focal point on the CCD,

analog RGB output or analog single color output.

108. automatic servo-motor controlled semi-wide angled movie camcorder lens (“bug-nose”).

112. moving picture expert's group (MPEG IV) optimized infrared/visible light charge coupled device (MPEG CCD),

Bayer filtered red, green, blue from a single CCD for low cost as opposed to a red CCD, green CCD, and blue CCD,

Smart passively focused using visible light image contrast at the motion focal CCD (x,y) point input from either the micro-processor/micro-controller's motion model for all moving suspects or else using the point of strongest infrared heat image (x, y) focal point on the CCD.

Analog RGB output or analog single color output.

116. automatic servo-motor controlled telephoto 35 mm to 70 mm/105 mm zoom still camera lens (“bug nose”)

(telephoto angle—no mechanical but fully electronic pan and tilt, zoom, automatic subject frame centering or electronic framing and electronic focus, fine contrast focus adjustments from the passive CCD servo-motors).

120. focal plane array based motion sensor (“bug mouth”),

Not ordinary motion sensor which gives a Boolean yes/no motion reading,

Not a warm blooded or remote hand “pan and tilt” video camera with an active infrared imaging system which focuses upon heat images on the infrared/visible light CCD. Fully unattended operation is desired using no warm blooded or no remote hand “pan and tilt” operations.

In the preferred embodiment, a small cluster of outwardly pointing infrared light diodes transmit infrared light out in all directions by using an infrared diode array. The infrared light combines with natural body heat and is reflected off of both moving and still heat images to form an infrared heat image upon a combined, low cost, infrared/visible light CCD. The strongest moving heat image gives the (x, y) CCD focal point to do passive visible light focus using fine-adjustments on the camera lens.

In the 1^{st} alternative embodiment, the low-cost dedicated focal plane array model, a dedicated infra-red diode, outwardly pointing cluster is used. Also a dedicated single infrared CCD is used with a beefed-up, single, advanced reduced instruction set computing (RISC) micro-processor (strong ARM) chip set used for motion control computer model focal plane CCD coordinates of (x, y, heat image intensity, time, optional z-axis range) of many moving suspects as well as for image byte shuffling.

In the 2^{nd} alternative embodiment, the high-cost dedicated focal plane array model, a hybrid system is used with a focal plane array of infrared light diodes and also a dedicated infrared/visible light CCD plus sonar processing. A more powerful advanced risk micro-processor (ARM) will run algorithms such as a moving suspect motion control model to track all moving suspects, target designation algorithms, clutter rejection algorithms, object and shape recognition algorithms, a visible light image reverse MPEG IV two views of 2-dimensional image to one view of 3-dimensional moving texture map model not currently supported by MPEG IV.

In the 2^{nd} alternative embodiment, an additional and redundant array of speakers will sequentially transmit ultra-sonic sound beams going out in all directions. The sound waves are reflected off of a moving suspect with the Doppler effect and the received signals used in simple moving suspect ranging estimates (complex sonar processing or Doppler suspect speed is not used). The transit time of the sound wave divided by two multiplied by the speed of sound in air gives the range to the moving suspect which is added to the motion control computer model parameters. The passive visible light auto-focus is done on a selected motion control computer model image. The technique of leaving a foot ruler attached a known distance from the camera is also used in 3-dimensional image models to give a moving suspect range estimate to be included in the computer motion model.

124. electric DC motors for lens control.

128. 32-bit micro-processor/micro-controller

Receives from the focal plane array motion sensor (120) the CCD coordinate plane (x, y, image heat intensity) point for each stationary or moving heat image suspect with quite possibly more than one.

Keeps a computer motion model of all still or moving heat images in the focal plane CCD coordinate point of (x, y, image heat intensity, time, optional range) of all moving suspects which allows selected or else sequential selection of a single heat image for “electronic pan and tilt” operations. “Electronic pan and tilt” operations upon a single image will give JPEG I still photograph focusing upon a single suspect of interest while the moving MPEG X video captures the sequence of events. Sequencing several still and moving suspects with “electronic pan and tilt” gives focused shots upon all suspects of interest. The output of the motion model is the CCD origin (x, y, image heat intensity, time, optional z-axis range) position of the focus subject,

Selects one sequenced or still moving heat image suspect from the motion model (the moving suspects may be selected using “electronic pan and tilt” to get fine focus still photos on each), and computes:

1). computes a “moving suspect focal CCD (x, y, image heat intensity, time, optional z-axis range) point” for passively focusing both a JPEG CCD and MPEG CCD which may have:

a). range>0 for a single moving suspect's distance

b). range=0 for a distance close up range with several moving suspects,

range=1 for a distance of medium range with several moving suspects,

range=2 for a distance of infinity range with no close range or no mid-range moving suspects detected,

Feeds the “moving suspect focal CCD (x, y, image heat intensity, time, optional z-axis range) position” to the DC motor control analog feedback circuitry (140),

Shuffles both of the MPEG IV and JPEG I digital, 32-bit true color (10 bits red, 10-bits blue, 10-bits green) digital video data from the ADC's (132) to the SDRAM (134) for collection of a single frame,

Shuffles the collected single frame of SDRAM (134) video to the JPEG I compression IC (144) for JPEG I compression,

Shuffles the SDRAM (134) video to the MPEG IV integrated compression IC (144, 152) for MPEG IV compression,

Shuffles compressed frames of video from the MPEG IV integrated compression IC (144) back to the SDRAM (134) for assembly into the new proposed MPEG IV level S1/E1 video streaming data,

Shuffles the new proposed MPEG IV Level S1/E1 video stream to the NIC (164) for network output,

Inputs control information from the network interface card (NIC) (164),

Outputs status information back to the network interface card (NIC) (164).

In the 1^{st} alternative embodiment and 2^{nd} alternative embodiment the micro-processor/micro-controller may be upgraded to a powerful micro-processor in order to maintain a visible light frequency 3-dimensional image model using the technique of a foot ruler in the field of view attached at a known distance.

(future upgrade) to a 512 Mega Hertz 32-bit strong advanced reduced instruction set computing (RISC) micro-processor (strong-ARM), a two to n chip-set with micro-processor bus and additional micro-processor bus support chips (see advantages section). Possibly future upgraded to a future specialized, single integrated circuit (IC) strong ARM micro-controller for cost reduction),

(future upgrade) to a cryptographic advanced RISC micro-processor (crypto-arm) 2 to n chip set with a built-in tamper resistant non-volatile electrically erasable programmable read only memory (TNV-EEPROM) or cryptographic memory for the secure storage of cryptographic keys used for secret key cryptography and public key cryptography (see advantages section). This specific crypto architecture with a separate integrated chip in the chip set of a dedicated MPEG X digital compression only chip (a dedicated MPEG X digital decompression only chip will be useful in other applications) will support the ‘cipher text (session key encrypted)’ digital media of Cross-Reference To My Related Inventions, U.S. Provisional Patent Application [REF 516]. The crypto-ARM micro-processor is heavy duty for MPEG X/proposed MPEG IV Level S1/E1 control stream packaging with bus-master DMA controllers used for ‘dumb’ byte shuffling over the PCI I/O bus. The cryptographic keys for the crypto RISC micro-processor chip set will be obtained from pass-thru encryption over open (‘red’) computer buses such as a smart card reader attached by universal serial bus (USB) with the smart card also serving as a portable vault with its own TNV-EEPROM holding portable cryptographic keys. The crypto-microprocessor also called a crpyto-CPU can serve as a cryptographic key distribution center to distribute the uploaded keys from a smart card through-out the computer system in ‘crypto memory to crypto memory’ only crypto key transfer processes using pass-thru encryption over wiretappable computer buses. Sequence numbers will prevent ‘recorded replay attacks’ even without the use of synchronized clocks. The crypto-strong ARM chip set will have built in intermetallic layer impedance monitoring on-chip to detect pin probers used by chip hackers. The chip set will also have inter-chip set high speed buses with impedance monitoring to detect pin probers used by chip hackers. Chip hacker activity through pin-prober impedance monitoring once definitely and reliably detected will simply erase the on-chip cryptographic memory holding the desired cryptographic keys.

130. (future upgrade) broadband cable MODEM PCI bus plug-in card

Based upon prior art in one full-duplex transmit/receive channel in a single integrated circuit with use of a coaxial cable local area network (LAN)/wireless LAN for built-in connection of a digital security camera to a PC for data logging and human man machine interface (MMI) monitoring at the PC.

(Future upgrade) for a lowest cost/digital camera design which supports a ‘cipher text’ session key encrypted audio/video data stream. A local area network (LAN)/wireless IEEE 802.11b/c/g LAN connected string of digital security cameras can be connected to a single PC acting as a man machine interface (MMI) viewing station which does vital frame merging and frame sequencing absolutely necessary to reduce recorded digital bandwidth to a digital DV (R) tape recorder. Use of a strong-ARM micro-processor for automatic local digital cameras level motion control modeling and central coordination along with bus support for DMA controllers for ‘dumb’ I/O bus byte shuffling on the digital camera end is allowed by a separate peripheral components interconnect bus (PCI) I/O bus connected digital camera motherboard COMMOD/DEMODEC chip which supports built-in LAN/wireless LAN networking. The COMMOD/DEMODEC chip is a symmetrically designed one transmit channel and only one receive channel one integrated circuit (IC) design. The combined one transmit channel compression/modulator (‘COMMOD’) and a single receive channel demodulation/decompression (‘DEMODDEC’) COMMOD/DEMODEC chip for use with a local area network (LAN) design to support a typical systems configuration consisting of:

1). arbitrary numbers of digital security‘video-cameras connected by a front-end local area network (LAN)/wireless LAN for the digital cameras.

2). use of a PC based station (‘No-Zone Mirror [REF 504, REF 508]’) for heavy duty CPU [2.0 Giga Mega Hertz] through-put digital frame merging, frame sequencing, monitor viewing, man machine interface (MMI) and digital recording station using DV (R) tape cartridges and optional back-office viewing station end. This is a two LAN system with a digital camera front-end LAN/wireless LAN and a back-end LAN for PC based digital recording, color printer access. The video is a prior art Accelerated Graphics Port (AGP) card (dummy downed PCI bus intended for highly asymmetric video data mostly ‘3-D texture maps’ going from system SDRAM connected to the PCI mezzanine bus controller chip to the AGP card). This PC provides the necessary user prioritized, video frame merging and video frame sequencing and video data reduction function to minimize video data for limited tape storage bandwidth [3 Mega bits/second up to 300 Mega bits/second depending upon multiple DV (R) tape drive costs and ‘tape striping’] and space.

A single COMMOD/DEMODEC or advanced cable MODEM chip with a COMMOD circuit or 1/2-MODEM silicon compiler library function grouping of known highly asymmetric communications channel circuits gives one transmit audio/video MPEG IV/proposed MPEG IV level S1/E1 channel for a single digital camera. A digital camera end same single chip COMMOD/DEMODDEC with its additional demodulation and digital decompression gives a one count of receive channel for digital hand-shaking data usable on the digital camera end.

The known functions supported in the COMMOD/DEMODEC chip will be arranged in a front-side bus to the main chip functions, low-speed PCI I/O bus interface, and a high-speed back-side bus to the main chip functions, a high-speed on-chip I/O bus with on-chip SDRAM used as a working queue:

a). built-in MPEG IV/proposed MPEG IV level S1/E1 digital compression (redundant to any other MPEG IV digital circuitry such as a separate dedicated MPEG IV integrated circuit of mixed integrated circuit silicon compiler library function) with future upgrade to new with this invention proposed MPEG IV Level S1/E1 circuitry (must be done first in sequential process order). MPEG X/proposed MPEG IV level S1/E1 control stream production and assembly of the control stream, high data rate video stream, low data rate audio stream, lowest data rate JPEG X stream. A separate back-side bus I/O channel and on-chip backside DMA will act upon the high rate uncompressed digital MPEG X (4,1,1), (4,2,2), or (4,4,4) macro-blocks of a maximum of rows of pixel strips which are 32 rows wide by 32 columns long which are already accumulated in PCI bus SDRAM, the medium rate uncompressed digital audio data in the PCI bus SDRAM, and the very low rate uncompressed JPEG X digital still picture data in the PCI bus SDRAM for transfer to on-chip backside bus SDRAM.

b). built-in DES (R) or other secret key encryption of 64-bit cipher blocks in several block chaining modes and stream cipher modes with some modes of block chaining very sensitive to bit errors (must be done second in sequential process order), separate I/O channels and on-chip back-side I/O bus bus master DMA from on-chip SDRAM will act only on already fully digitally compressed MPEG X/proposed MPEG X level S1/E1 data in the on-chip back-side bus SDAM (level 1 backside bus cache). DES clocks out data at the same rate as clock in with an approximate 50 clock latency (meaning the entire output stream must be encrypted at once or a pipe-line stall occurs with garbage data from 0's input). The PCI bus SDRAM chip will have bus master DMA transfer of memory to I/O port with scatter-gather of discontiguous SDRAM memory. Separate independent I/O channels with on-chip bus master DMA transfer back to back-side bus SRAM (Level 1 on-chip back-side bus cache).

c). built-in Reed Solomon (RS) block error detection and correction generation circuitry of greater power than the consumer electronics standard of RS (255×8, 223×8) (about 10% extra parity bits are added to data) important for certain cipher block chaining (CBC) modes, the DES encrypted ‘cipher text’ streaming media from b) can be directly RS processed and sent directly to the modulation function in step d) with empty queuing space on the back-side bus on-chip SDRAM with independent channel on-chip bus master DMA to from on-chip SRAM (level 1 back-side bus cache) in a separate queue.

d). and built-in Trellis Coded Quad Phase Shift Keying (TC-QPSK or “Viterbi Coding”) circuitry used with the use of concatenated mode of TC-QPSK (for superior error correction) combined in a hybrid manner with RS coding (for superior error detection) to piggy-back the compressed digital audio/video signals upon several analog carrier frequencies used for digital broadband cable modems. Independent I/O channel for on-chip bus master DMA transfer from on-chip SRAM (level 1 back-side bus cache).

A separate DEMODEC circuit 1/2 MODEM silicon compiler library function on the COMMOD/DEMODEC (broadband MODEM) chip includes a back-side high speed on-chip bus to on-chip SRAM (back-side bus level 1 cache) and the front-side low speed PCI bus. Only one receive channel is needed for a reverse built-in demodulator/decompression (“DEMODDEC”) grouping of known circuits done in reverse sequential order to undo the above functions:

a). and built-in Trellis Coded Quad Phase Shift Keying (TC-QPSK or “Viterbi Coding”) circuitry used to de-piggy-back the compressed digital audio/video signals off of the analog carrier frequency used for broadband cable modems. Separate on-chip back-end bus DMA bus master transfer to on-chip SDRAM and block queuing.

b). built-in Reed Solomon (RS) block error detection and correction generation circuitry important for certain cipher block chaining modes used in hybrid concatenated mode along with TC-QPSK error correction, with possible back-side bus on-chip SRAM queuing (level 1 back-side bus cache) using on-chip bus master DMA.

c). built-in DES (R) or other secret key decryption in several block chaining modes and stream cipher modes with some modes of block chaining very sensitive to bit errors (must be done third to reverse the above sequential process actions) with back-side bus on-chip SRAM queuing (level 1 back-side bus cache) using on-chip bus master DMA channels.

d). built-in MPEG IV/proposed MPEG IV level S1/E1 digital de-compression with future upgrade to proposed MPEG IV Level S1/E1 (must be done last to undo the above sequential process order), with front-side PCI bus SDRAM chip queuing using on-chip bus master DMA channels. The back-side bus on-chip SRAM queuing (level 1 back-side bus cache) uses on-chip bus master DMA channels.

The PC end in some cases does MPEG-IV/proposed MPEG-IV Level S1/E1 which allows intelligent user controlled frame merging and frame sequencing, monitor viewing of frame merged and frame sequenced digital uncompressed MPEG X audio/video data, and queuing up on hard disk work queues for eventual slow storage to DV (R) digital tape (with MPEG IV re-compression) through a DEMODDEC group of functions/circuits, or TC-QPSK demodulation and MPEG IV decompression, with DES session key decryption, which supports as many silicon compiler library based communication channels as the transistor and size budget permits for multiple digital cameras. Intelligent frame merging and frame sequencing in the PC using up to eight channels per frame or video digital sequencing modes of up to ten channels per frame or a hybrid combination will sharply reduce storage digital data with the digital recording bandwidth rate the huge bottleneck in the system.

A PC end COMSTOR silicon compiler placed on-chip circuit will MPEG IV re-compress the frame merged and frame sequenced data, session key encrypt it, RS parity check it, and queue it up on hard disk work queues for eventual slow DV (R) tape storage. A PC end DEMODSTOR silicon compiler placed circuit on-chip will store without viewing the incoming from the LAN already compressed and session key encrypted digital MPEG IV data with as many channels as required in the transistor budget for multiple digital camera support. The PC end of the transmitted back to each digital camera single digital channel will have a single TC-QPSK modulation circuit for low-rate, hand-shaking control digital data in a highly asymmetric communications channel (requiring only 1.5 Mega bits/second going back to all digital cameras in the cable loop).

A future option for the lowest cost PC end of a proposed DEMODDEC silicon compiler circuit placed on-chip with as many channels as the transistor budget allows for handling incoming 10-20 multiple digital security cameras with possible Ethernet local area network office support for the back-end wired LAN going to a color printer/audit trail data logger. The TC-QPSK demodulation, RS parity error detection and correction, session key decryption, and MPEG IV digital decompression leaves error detected and corrected, ‘plain text (decrypted)’, uncompressed, digital monitor viewable digital data for PC frame merging and frame sequencing. This frame merging (up to a user dynamically selected eight digital panels per frame or screen) and frame sequencing (slow and fast sequencing of up to 10 levels deep at a maximum of one frame/second) greatly reduces the hard disk work queue stored data for storage with the DV-tape storage rate [3 Mega bits/second] per single tape up to [300 Mega bits/second] using ‘striping’ with multiple tape drives being the main bottleneck in the entire system. Any excess audio/video data must be stored on auxiliary tape units with removable DV (R) tape modules or else discarded. The frame merged and sequenced frame must be put through a COMSTOR silicon compiler placed on-chip circuit for MPEG IV digital re-compression, session key re-encryption, RS parity coding, and hard disk work queuing for eventual storage on slow digital DV (R tape.

A future option proposed PC end separate DEMODSTOR circuit or TC-QPSK demodulation and queuing up for hard disk work queue storage for eventual slow DV (R) digital tape storage done by on-chip silicon compiler library circuits for the MPEG IV/proposed MPEG IV Level S1/E1, which is already digitally compressed audio/video data will be on the PC end.

A future option proposed PC end separate PLAYDEC or DV (R digital tape queued retrieval to hard disk work queues of the MPEG IV/proposed MPEG IV Level S1/E1 which is already digitally compressed audio/video data, MPEG IV/proposed MPEG IV level S1/E1 digital decompression and PC digital monitor viewing.

132. analog to digital converter (ADC) with first in first out (FIFO) buffer,

outputs: y. 2000 32-bit True Color mode: 10-bits red, 10-bits green, 10-bits blue (RGB).

133. electrically erasable programmable read only memory (EEPROM)

permanent non-volatile computer program store which is down-loadable at the factory over a serial data link.

134. synchronous dynamic random access memory (SDRAM) integrated circuit (IC)

used to store the 3-6 mega pixel JPEG digital both before compression and after compression photos. Input/output in SDRAM's (n×8 chips/byte×1 Giga bit/IC with RS coding in the data) is sequentially over-lapped clocked out by I/O bus cycle per bit vs. older DRAM (9 n×1 chips/byte with one parity bit) which is clocked out in one clock cycle per bit by I/O bus cycle.

135. tamper resistant non-volatile electrically erasable programmable read only memory (TNV-EEPROM)

used for internal micro-processor/micro-controller storage of cryptographic key values (e.g. secret keys, session keys (one time secret keys), public keys/private key pairs). An internal to a chip intermetallic layer with impedance monitoring will erase the TNV-EEPROM with evidence of a chip hacker using a ‘pin prober.’ A n-chip crypto micro-processor set will use bus impedance monitoring circuitry to detect for a chip hacker using a ‘pin prober’ to erase TNV-EEPROM.

136. static random access memory (SRAM)

used for variables temporary store for embedded computer program execution which is limited size but much faster than SDRAM memory given SRAM's flip-flop construction composed of a minimum of four transistors per memory bit vs. one transistor and one capacitor (with read/write delays) used in SDRAM.

140. DC motor control analog feedback circuitry,

inputs from the micro-processor/micro-controller (132) the “moving suspect focal CCD (x, y, image heat intensity, time, optional z-axis range) position” from the focal plane array motion sensor (120)):

a). range>0 for a single moving suspect's distance

b). range=0 for a distance close up range with several moving suspects,

range=1 for a distance of medium range with several moving suspects,

range=2 for a distance of infinity range with no close moving suspects or mid-range moving suspects detected,

adjusts lens for maximum contrast on the charge couple device (CCD) (104, 112) focal length distance of the CCD using CCD contrast inputs at the “moving suspect focal CCD (x,y,z)position.”

May have two separate lenses for the JPEG CCD and the MPEG IV CCD.

144. proposed JPEG I/MPEG IV digital compression circuitry (possibly a combined integrated circuit or IC),

Does JPEG I only color model conversion from the CCD/ADC's digital RGB color model, to JPEG I's CYMK color model, and unique JPEG I digital compression. Processes ADC produced groups of rows/still picture frame at low data rates but at high resolution/frame.

Can possibly use the similarity of MPEG IV I-Pictures only and JPEG I lossy format compression for common circuitry with prior art in the JVC (R) Corp. hybrid JPEG/MPEG IV either/or camcorder which produced only MPEG IV I-pictures and no P-pictures or B-pictures at a 10 times higher data rate than standard MPEG IV.

MPEG IV digital compression circuitry,

Does MPEG IV only color model conversion from the CCD/ADC's digital RGB color model, to the MPEG IV YCbCr color model, and unique MPEG IV digital compression. Processes MPEG X macro-block pattern defined groups of rows/single movie frame which are high data rates but lower resolution/frame. Generates for completed frames only a MPEG X control stream, a high rate MPEG X video stream of compressed digital data, a low rate MPEG X audio stream of compressed digital data, and a very low rate JPEG X still picture stream all with presentation time stamps (PTS's).

Can possibly use similarity of MPEG IV I-Pictures only and JPEG I lossy format compression for common circuitry as in prior art JVC (R) digital camcorders with only I-frames and no use of P-frames and no use of B-frames to avoid motion study motion vector estimation problems and timing lags of up to ¼ to ½ second.

Computes Data Encryption Standard (DES) secret key encryption only (the highly asymmetric communications link return channel to the digital camera does only very low data rate micro-processor based software DES decryption) of the presentation time stamped (PTS'd), combined data streams with a control stream layer. DES is based upon 64-bit cipher blocks for both input and output. DES data is clocked out at the same clock rate of input with a maximum approximate 50 clock latency (meaning the entire output stream must be encrypted at once). Separate I/O bus on-chip bus master DMA with on-chip bus master DMA channels with ‘scatter-gather’ in PCI bus SDRAM chip physical memory and SDRAM queuing is used. On-chip SRAM (level 1 backside bus cache) in a back-side bus with on-chip DMA used for a working queue will free up PCI bus clogging.

Computes RS parity coding in the final digitally compressed frames. RS (255×8, 223×8) coding is standard for consumer electronics use. RS parity coding (strong in error detection but not error correction) is used in a hybrid mode with concatenated TC-QPSK in the MODEM function (strong in error correction but weak in error detection). On-chip bus master DMA channels does I/O transfer to SDRAM. On-chip SRAM (level 1 back-side bus cache) in a back-side bus with on-chip DMA in a working queue will free up PCI bus clogging.

148. duo-port random access memory (DPRAM),

152. video random access memory (VRAM),

video duo-port memory of larger density and higher cost than DPRAM used for I/O bus interfaces.

154. analog (modulated digital) R′G′B′ random access memory digital to analog converter (analog R′G′B′ RAMDAC)

156. first in first out (FIFO) buffer,

Only certain one-way, write only (with write status read-back option) FIFO latches for closed loop circuit motor control for the two lenses interface to micro-processor/micro-controller computed servo-feedback control firmware algorithms through use of the write FIFO as both a separate Gain (G-box) for new lens position and a separate read FIFO used as a Hold (H-box) for current lens position status. The two FIFO's also have analog discrete logic or mixed-circuit (analog/digital) application specific integrated circuit (ASIC) standard cell library glue logic for closed loop servo-motor control circuitry. The (G-boxes) have analog discrete logic for closed loop servo-motor control to move the servo-motor controlled lens automatically to a certain lens position. Hold circuitry (H-boxes) in servo-motor control to read a current lens position is internal to the servo-motor control circuit.

164. network interface card (NIC),

cable modem interface (modulator/demodulator), line amplifiers,

IEEE 802.11 b/c/g wireless local area network (wireless-LAN),

(optional) future use of fiber optic transceiver which outputs full digital data as 1's or 0's pulses of light.

168. micro-processor/micro-controller computer bus.

172. direct memory access (DMA) controller(s)

(dummy downed micro-processor for doing byte level input transfer of I/O port to memory and outgoing transfer of memory to I/O port.

Usually included as a two channel system (common or shared) DMA controller on-chip in micro-processor/micro-controller circuitry, but, not in micro-processor circuitry.

Micro-processor circuitry with a PCI bus uses an on-peripheral chip/I/O board dedicated bus-master DMA controller which negotiates to take over the entire I/O bus in memory to I/O port operations.

‘Scatter gather’ discontinuous bus master DMA mode supported from PCI bus SDRAM chip memory chained blocks out to an I/O port with the bus master DMA controller.

176. liquid crystal display. (LCD)

(for swivel out and tilt up/tilt down maintenance checking use) inputs analog (modulated digital) RGB color model signals.

200. hybrid MPEG X/JPEG X audio/video stream called new proposed MPEG IV Level S1/E1 (PROPOSED USER ENHANCEMENTS TO THE MPEG IV STANDARDS)

201. system time clock (STC)

MPEG IV hardware digital timer specified for the MPEG IV play-back unit.

202. program clock reference (PCR)

MPEG IV initialization value for the re-play MPEG IV device's hardware clock setting.

204. presentation time stamp (PTS)

MPEG IV maximum interval for re-play frame calibration is 700 milli-seconds (7/10^{th} of a second). The MPEG IV re-play unit can skip frames to re-sync or else slightly slow down play or slightly speed up play. The human eye and brain is very perceptive to any ‘jerky motion’ which is not very precisely clocked out in exactly equal intervals.

206. “silhouette-like technique” time stamps/position stamps/video channel data/electronic TV guide data uses a cryptography technique to store digital data in static background scene areas of each and every frame.

The use of standard MPEG IV ‘user data extensions’ to the video stream for very low data rate and suspendable ASCII text such as closed captioning for the hearing impaired, European tele-text, interactive TV guide data, advertising break advanced warning information, etc. will introduce too much over-head on every frame uses such as GPS date stamps, GPS time stamps. (good to 1 micro-second at the frame processor), GPS position stamps, GPS delta position stamps, inertial reference unit (IRU) angle data, IRU translation data.

208. hybrid MPEG X/JPEG X video only stream

simultaneous-mode of both high rate and medium resolution/frame MPEG X and low rate and high resolution/frame JPEG X.

212. JPEG intra-picture (I-picture) high resolution still pictures using JPEG X format:

Discrete cosine transform (DCT) for time domain to frequency domain lossy conversion (non-MPEG X compatible).

Lossy run-length encoding (RLE) (maximized runs of O's) with 1's converted to 0's to maximize strings of 0's on low frequency components sorted by the discrete cosine transform (DCT) to minimize loss of visual detail.

Huffman coding (baseline mode JPEG) bit patterns in a table and repeat count, or arithmetic coding in lossless JPEG.

Non-MPEG X compatible cryptography “silhouette like” technique for storing time stamps, date stamps, position stamps, attitude stamps, video channel id, electronic channel guide information, etc. which replaces the much less bandwidth efficient and throughput efficient MPEG II standard “user data descriptors” or “stream extensions”.

216. MPEG X intra-picture (I-picture)

Discrete cosine transform (DCT) for time domain to frequency domain lossy conversion.

Lossy run-length encoding (maximized runs of 0's) with 1's converted to 0's to maximize strings of 0's on low frequency components sorted by the discrete cosine transform to minimize loss of visual detail.

Huffman coding or bit patterns in a table and repeat count.

No MPEG X predicted-pictures (P-pictures) are used in critical motion recording due to timing slops and FALSE predicted motions.

No MPEG X in-between pictures (B-pictures) are used in critical motion studies due to FALSE motion vectors, over-shoots, and timing slops.

Non-MPEG X standard compatible cryptography “silhouette like” technique for storing time stamps in each and every frame: date stamps, position stamps, attitude stamps, video channel id, electronic channel guide information, etc, which replaces the much less bandwidth and throughput efficient plus high software over-head use of “user data extensions” or “stream descriptors” which are intended for much lower data rate data which can even be postponed during high actions shots which take excessive MPEG X through-put:

Frame re-ordering before output with higher resolution JPEG photo frame received last per presentation time stamp, but, re-ordered to first in the output data stream to allow plenty of higher resolution de-compression time at the other end.

220. MPEG X audio only stream

24-bits/sample digital audio at a 56 Kilo Hertz sampling rate.

Lossy audio perceptual shaping done to reduce bandwidth—high frequency soft noise next to low frequency loud noise is dropped out.

224. (Optional) Law Enforcement Access Field (LEAF)

(Technical Option) This field is used only for court ordered law enforcement use only [REF 516]. It uses an embedded movie ticket concept of pre-set counts of ‘free movie plays’ without revealing any cryptographic key data from cryptographic key escrow where:

Media Distribution Party Vendor (Party V),

Law Enforcement Party (Party L),

Federal, state, or local courts (Party C).

Notation: PuK-C is the Public Key for Party C,

PrK-V is the Private Key for Party V,

where cryptographic keys are contained in smart cards and cryptographically secure hardware and US National Computer Security Center (NCSC) Common Security Program (COMSEC) rated A1 (highest COMSEC validated and verified government level) down to B3 (lowest secure facility level) computers wherever possible.

Then the LEAF is:

Family Key Pass thru encrypted

{PuK-C(PuK-L(Play Codes, Play Counts)), PrK-V(Message Digest Cipher (MDC,) of above)}.

NOTE: The last line is a vendor public key digital signature of the LEAF.

### Referenced Parts of Invention (Medium Cost, 1^{st} Alternative Embodiment Only)

600. infrared (IR) diode (diode transmitter plane array)

used in a low-cost simple outwardly facing cluster

604. infrared/visible light charge coupled devices (focal plane CCD array)

combined for low-cost. Redundant to the visible light MPEG CCD and the JPEG CCD.

608. analog to digital converter (ADC)

### Referenced Parts of Invention (High Cost, 2^{nd} Alternative Embodiment Only)

696. infrared (IR) diodes arranged in an array used in a high cost outwardly facing cluster

700. dedicated infrared/visible light charge coupled device (HYBRID FOCAL PLANE CCD) more than one unit can be arranged in an expensive focal plane array of sensors depending upon security coverage needs

optimized to give sharper infrared images

a separate infrared/visible light CCD with a dedicated infrared CCD may also be used.

redundant to the MPEG CCD or the JPEG CCD.

702. analog to digital converter (ADC)

704. CCD coordinate plane

uses CCD coordinate point (x, y, image heat intensity, time, optional z-axis range, optional shape, optional size, optional spherical coordinates)

708. z-axis range to moving target hybrid design

an ultra-sonic sound emitter/sonar receiver may be used.

attaching a foot ruled measuring stick-on tape with visually clear foot and inch markers at a known distance in the camera field can give very inexpensive and specialized ‘machine vision’ distance solution using visible light, with a reverse direction two view 2-dimensional to a single view of 3-dimensional image model range estimates using MPEG IV moving texture mapping and measured distances.

Kept in the focal plane CCD coordinate point of (x, y, image heat intensity, time, optional z-axis range) used in the computer motion model.

Kept in a 3-dimensional motion model using spherical coordinates (alpha, beta, range) to moving target.

712. dedicated visible light focal plane array coordinates

Centered at center of visible light CCD plane. Uses CCD coordinates of (x, y, image heat intensity, time, optional z-axis range) used in the computer motion model.

716. spherical coordinates (alpha, beta, suspect range)

720. dedicated visible light MPEG charge coupled device (MPEG CCD)

724. foot ruler marked stick-on tape with clear visual markings for feet and inches at a known distance of z-axis offset which will be programmed into the micro-processor

728. 32-bit strong advanced risk micro-processor (strong-ARM)

does computer motion model calculations. Possibly does MPEG X/proposed MPEG IV Level S1/E1 control stream final assembly.

730. ultra-sonic emitter speakers aimed in different directions

732. ultra-sonic microphone receivers aimed in different directions

734. sonar processing algorithms

736. visible frequency light laser emitters aimed in different directions

738. reflected laser light charge coupled device (LASER CCD) aimed in different directions

740. laser light algorithms

### Not Part of Invention

800. single moving suspect.

804. local area network (LAN).

Can be a full digital 1.0 Giga bits/second coaxial cable with a broadband modem interfaces on the “head-end (personal computer)” and the “downstream end (video camera)” with combined shielded signal/control with a separate power line having uninterruptible power supply (UPS) back-up.

Can be a digital fiber optic cable in single-mode fiber (single light frequency) with 1.0-3.0 Giga bits/second bandwidth or multi-mode fiber (multiple light frequency) with 100.0 Giga bits/second bandwidth.

805. broadband cable modem circuitry/network interface card (NIC)

gives a maximum of 1.0 Giga bits/second of digital bandwidth

806. broadband fiber optic circuitry/network interface card (NIC)

single mode fiber gives a maximum of 1.0-3.0 Giga bits/second of digital bandwidth.

Multi-mode fiber gives a maximum of 100.0 Giga bits/second of digital bandwidth.

808. personal computer (PC) viewing station.

809. uninterruptible power supply (UPS)

810. digital computer monitor

812. video telematics no-zone electronic rear view mirror viewing station.

Specialized GPS satellite navigation/communications/video computer

816. digital computer tape video logging station.

820. nickel cadmium (NiCad) re-chargable battery for emergency power failure

Can be re-charged by a power line in the local area network (LAN).

### VII). DETAILED DESCRIPTION OF THE DRAWINGS

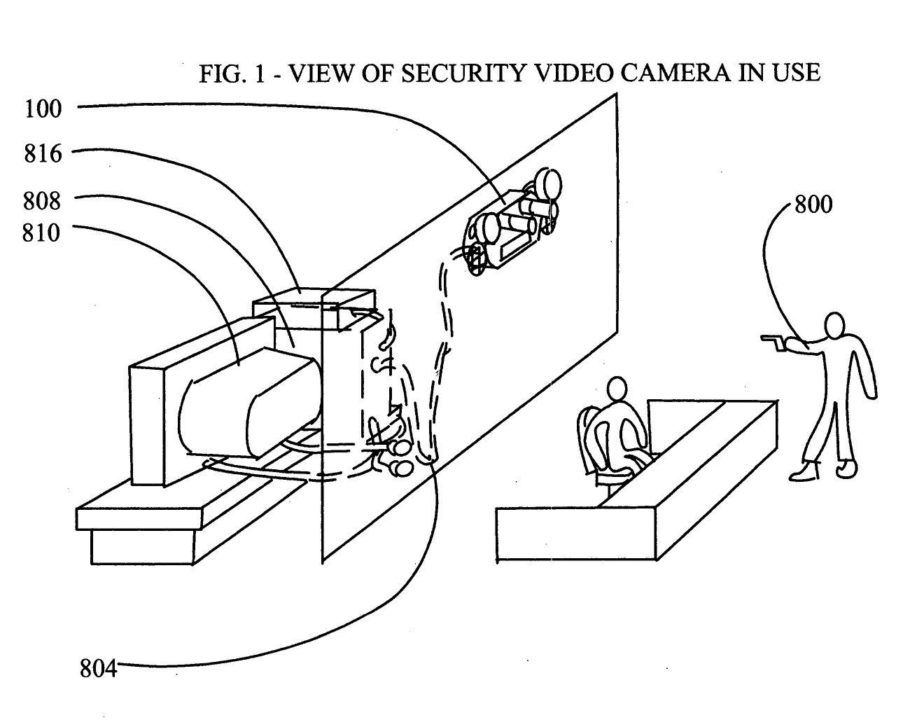

FIG. 1 is a diagram of an unmanned, fully automatic, security installation. The focal plane array based motion sensor (120) of the hybrid JPEG/MPEG X security video camera (100) is positioned to sense angles and distance and then precisely capture moving suspects. The moving suspect (800) is shown. The local area network (LAN) cable (804) is shown leading away from the hybrid JPEG/MPEG X security video camera (100). A security room personal computer (PC) viewing station (808) is shown. A digital computer tape video logging station (816) is shown.

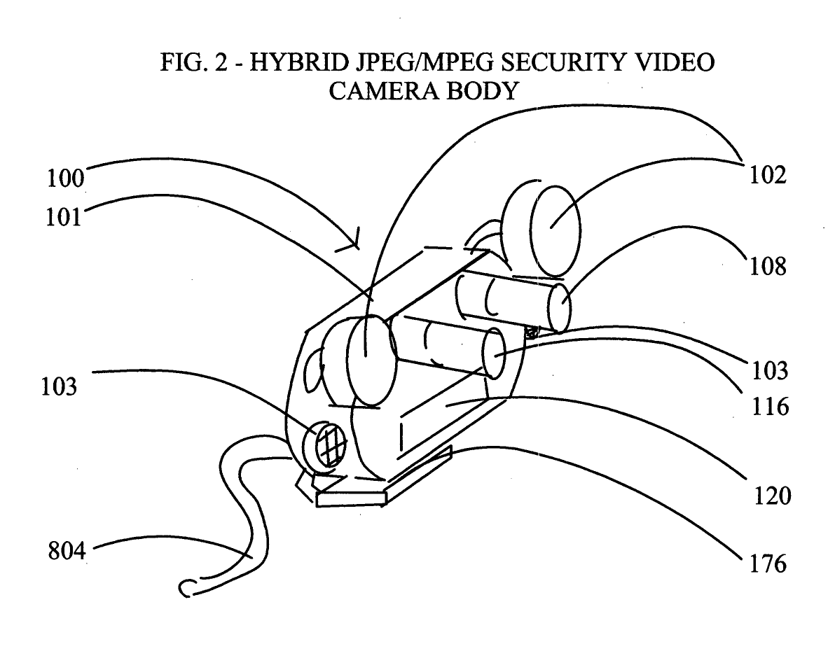

FIG. 2 is a mechanical diagram of a hybrid JPEG/MPEG X audio/video camera (100), “bug face,” with major components located in the housing, “bug body”. Shown are the video camera body, “bug body,” made of aluminum or plastic or both (101), the “bug eyes” or the low power florescent lights (102), the “bug ears” or the stereo micro-phones on both sides for stereo separation (103), the two “bug noses” or the servo-motor controlled wide angled lenses (108, 116) in a duo-lens system, the “bug innards” or the inner video camera electronic components, the “bug mouth” or the focal plane array based motion sensor (120), the swing-out and tiltable rear or bottom facing liquid crystal display (LQD) (176), the network interface card (NIC) (164) cable connection to the local area network (LAN) (804).

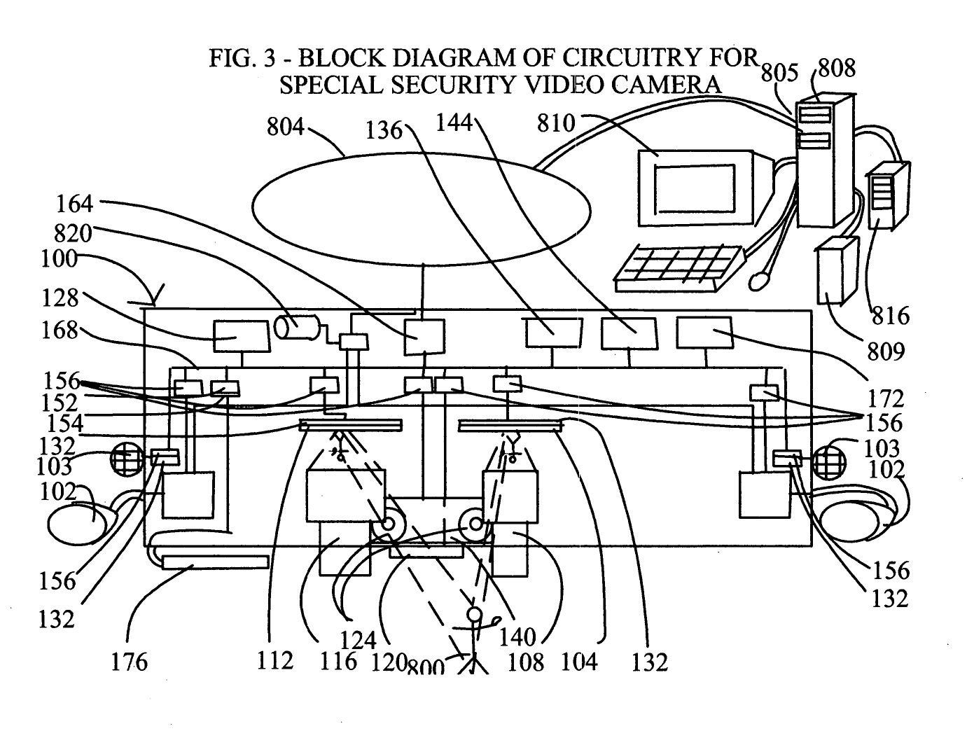

FIG. 3 is a system's block diagram at a chip level inside the audio/video camera (100).

Micro-processor/micro-controller (128) design is key:

Reads the moving suspect focal plane array data MPEG CCD coordinate point of (x, y, image heat intensity, time, optional z-axis range) from the focal plane array based motion sensor (120):

Activate the low-power florescent lighting with motion detected and deactivates them with no motion. No florescent lighting may still record infrared (IR) suspect heat images. Outdoor sensors may use highly directional, low amperage, arc-light lighting.

Computes and maintain the moving suspect(s) motion model. More than one moving suspect are sequentially subjected to “electronic pan and tilt” to get focused still suspect photos,

Electronic “pan and tilt” can be done with micro-processor/micro-controller scan line interpolation and introduction and electronic frame centering and frame cropping (remember that “digitally enhanced” pictures lose data and never adds any new data in unlike “optically zoomed” pictures), so, this function is really better suited for post-processing of MPEG X signals,

Computes the moving suspect focal MPEG CCD position (x, y, image heat intensity, time, optional z-axis range) for the charge coupled devices (CCD's) (104, 112).

Computes:

Range>0=z-axis distance to moving subject for a single moving suspect.

Range=0 means multiple moving suspects at close range.

Range=1 means multiple moving suspects at mid-range.

Range=2 means no close range or mid-range moving suspects, so, use infinite range.

Feeds the moving suspect focal length for the two CCD's (104, 112) to the DC motor control analog feedback circuitry (140).

The DC motor control analog feedback circuitry (140) inputs from the microprocessor/micro-controller (128) the computed moving suspect focal length.

Servo-motor control automatically fine adjusts lens for maximum contrast at the moving suspect focal length for the two CCD's (104, 112) using CCD contrast inputs across the motion focal length for each type of MPEG CCD and JPEG CCD.

Shuffles both of the MPEG.IV and JPEG I digital, 32-bit True Color (10 bits for red, 10 bits for green, and 10 bits for blue) digital RGB video data from the ADC's (132) to the SDRAM (134) for collection.

Digital RGB is sent to the liquid crystal display (LCD) (176) for user viewing.

Shuffles the SDRAM (134) video to the JPEG I/MPEG IV Integrated Compression IC (144) for JPEG I compression.

Shuffles the SDRAM (134) digital RGB video to the JPEG I/MPEG IV Integrated Compression IC (144) for matrix transform conversion to the YCbCr color model and then MPEG IV compression.

Shuffles compressed digital YCbCr video back to the SDRAM (134) for assembly into the new proposed MPEG IV Level S1/E1 video stream.

Shuffles the new proposed MPEG IV level S1/E1 video stream to the NIC (164) for network output.

Inputs control information from the NIC (164).

Outputs status information back to the NIC (164).

Networked Design is Key:

Standardized TCP/IP protocol network design transfers MPEG IV level S1 (PROPOSED MPEG standard) video data for digital video recording.

Digital video can be personal computer (PC) processed for JPEG I removal from the new proposed MPEG IV level S1/E1 standard and viewed on standard computer industry SVGA or UXGA computer monitors. Post-processing software packages can do “electronic enhancement” can do electronic zoom with scan line interpolation and introduction and frame re-centering and frame cropping.

JPEG I high resolution still photos can be extracted from the new proposed MPEG IV level S1/E1 (PROPOSED MPEG standard) and viewed on personal computers (PC's), printed on high resolution color, laser printers.

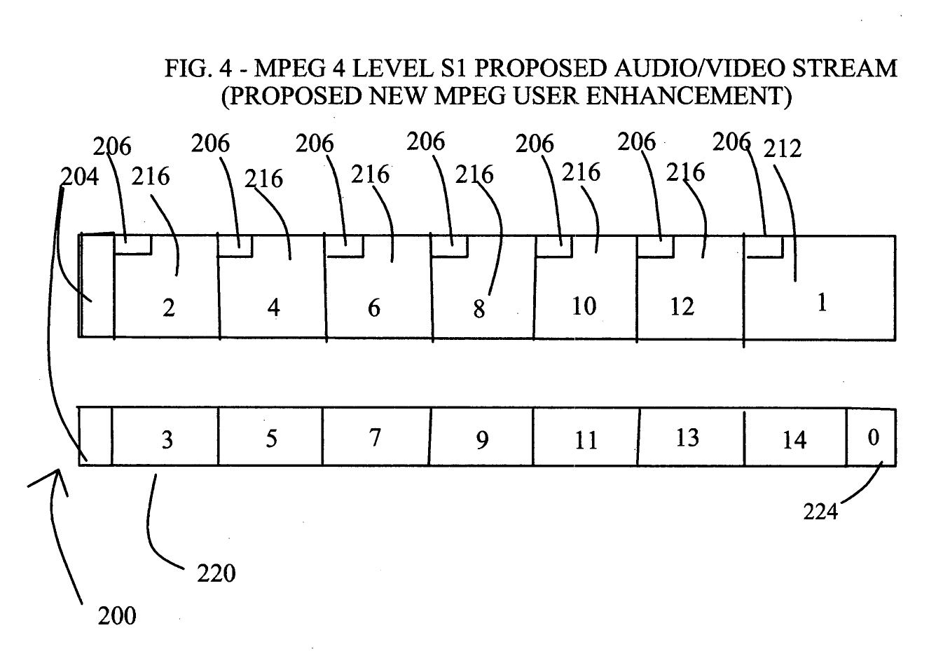

FIG. 4 is a timing diagram of the (proposed MPEG X standard) with this invention the new proposed MPEG IV level S1/E1 or in other words a hybrid MPEG IV and simultaneous JPEG data stream. This is not meant to be an MPEG X specification or user extension, but, merely an outline of how the invention (100) produces such a data stream.

### VIII). ADVANTAGES OF THE PREFERRED EMBODIMENT

A). An advantage of the invention in the preferred embodiment is to get rid of fuzzy frame buffer suspect ID photo's obtained from analog, NTSC security video cameras. It will also offer improved suspect photos over all digital compressed Digital Video (R) (DV®) video cameras which use non-MPEG compatible digital compression.

A fully unmanned, fully automatic security audio/video camera which uses a hybrid, SIMULTANEOUS use of JPEG and MPEG IV cameras and output format using both two dedicated CCD's, a JPEG I high resolution CCD and a MPEG X low resolution CCD, and two dedicated closed-loop servo-control lens systems is new with this invention. A stand-alone JPEG still camera combined with an almost stand alone MPEG IV audio/video camera combined to produce a SIMULTANEOUS combined very high resolution, still suspect photo for “mug shots” (low rate MPEG IV data stream with presentation time stamps and possibly GPS date, time, and position stamps on every frame) AND moving suspect audio/video for motion studies (high rate MPEG IV data stream with presentation time stamps and possibly GPS date, time, and position stamps on every frame) is new with this invention. A JPEG I CCD can be optimized for still pictures with high resolution for facial features. A MPEG IV CCD can be optimized for moving pictures done upon moving suspects with lower resolution and less data production. The new type of extensions to the MPEG IV. output data stream is called proposed MPEG IV level S1/E1 for security level 1/entertainment level 1.

This is accomplished by the use of the focal plane array motion sensor measuring the moving suspect, the focal plane CCD coordinates of (x, y, image heat intensity, time, optional z-axis range) data which is micro-processor/micro-controller computed into the computer motion model for many subjects, of which only one stationary or moving suspect is chosen for “electronic pan and tilt” auto-focus. This is done by using the computer motion model's CCD coordinates of (x, y, image heat intensity, time, optional z-axis range) to do passive auto-focus upon a single image. The single stationary or moving suspect, focal plane CCD coordinate of (x, y, image heat intensity, time, optional z-axis range) CCD position is input into the specialized JPEG and MPEG X passive auto-focus, charge coupled devices (CCD's). This gives very sharp auto-focus on the moving suspect instead of using an analog averaged mid-range distance focus. The use of fully digital audio/video formats gives noise tolerant signals for fully digital recording upon Digital Video (R) tape (mini-DV (R) audio/video tape, DV (R) tape, or streaming computer tape).

B). An advantage of the invention the preferred embodiment is to reduce the problem of grainy film wear using analog, NTSC security video signals on Dupont Mylar (R) film based 8 mm or Hi-8 mm video tape. Often even 10 overwrites of analog security video signals on brand new video tape produces graininess through hysteresis or magnetic field wear out which is also called magnetic coercivity.

This is accomplished by the use of noise tolerant, fully digital new proposed MPEG IV level S1/E1 audio/video which is recorded upon the fully digital tape.

C). An advantage of the invention the preferred embodiment is to support fully digital recording over the video local area network (video-LAN) to digital tape drives. Newer after y. 1999 digital video cameras use Digital Video (DV (R)) compressed digital color audio/video signals which can be de-compressed into digital data for 480 viewable line digital signals. The DV (R) video signals can be stored upon digital magnetic tape through the use of an industry standard, mini-video cassette (smaller than Hi-8 (R) format), mini-DV (R) digital video tape, or else upon wider format, and longer length, digital video DV (R) tape meant for commercial television and movie recording. These all digital formats are much less susceptible to film wear out from hysteresis (magnetic coercivity).

This is accomplished by the use of JPEG I and MPEG IV compressed digital video signals which are integrated into the new proposed MPEG IV level S1/E1 security video standard. The compressed digital DV (R) audio/video standard itself (as opposed to the digital tape format) is not used which is furthermore not compatible to MPEG X.

The older helical scanning video tape technology of analog signal video recording is replaced by computer digital tape recording technology of much more robust and compact up and down magnetic bars of computer binary 1's and 0's for much greater video storage per foot of video tape. The mini-DV (R) tape cartridges introduced commercially after y. 1999 was much thinner and smaller than a comparable in recording time and video quality, analog National Television Standards Committee (NTSC) signal which was stored upon the much older Hi-8 (R) (8 mm) tape cartridge.

This is accomplished by the use of commercial digital format mini-DV (R) or DV (R) tape cartridges, while ignoring the DV (R) audio/video compressed digital standard.

The invention will support the use of computer industry digital streaming tape drives with removable tape cartridges. In y. 2002, 300 Giga byte streaming tape cartridges are commercially used with 8 Mega byte/second per tape drive recording rates. A 300 Giga byte streaming tape cartridge will store 100,000 seconds of a very high data rate for motion recording MPEG IV format recording at a recording rate of 3 Mega bytes/second or 27 hours of full motion 30 frame/second audio/video.

This is accomplished by the use of the new proposed MPEG IV level S1/E1, security video standard transferred over the Video-LAN and stored upon a variety of permanent storage devices.

The invention will support the use of digital versatile disk read/write (DVD−RW (R) or DVD+RW (R)) video recording. In y. 2002, single sided and single density DVD's have 7 times the capacity of a compact disk (CD) or 7 times 700 Mega bytes/CD for 4.9 Giga bytes/DVD. Double sided and double density DVD's can store four times 4.9 Giga bytes or this amount or 19.6 Giga bytes of data (at a single channel audio/video new proposed MPEG IV level S1/E1 recording rate of 3 Mega bytes/second this will store about 6.5 thousand seconds or 1.8 hours of full motion recording at 30 frames/second which can be extended to 54 hours at a two frame/second freeze frame recording rate). A y. 1999 DVD is equivalent to a 24×CD in sustained data transfer rate or about 3.4 Mega bytes/second.

This is accomplished by the use of the new proposed MPEG IV level S1/E1, security video standard with use of a local area network (LAN) which will connect to a variety of permanent storage devices.

D). An advantage of the invention the preferred embodiment is to support the use of a video camera connection to fully digital video local area networks (V-LAN's) using broadband cable modems (physical cable used as a straight line bus but logically looped channels offers up to a maximum of 1 Giga bits/second digital bandwidth now available in y. 2002). Support future use of single mode (1 Giga bit/second digital bandwidth now available) and multi-mode fiber optic cable medium (100 Giga bit/second digital bandwidth now available). Fiber bus or star topologies supported with the star topologies using fast switching hubs much less vulnerable to vandalism or criminal sabotage (criminals may try to rip a bus based video camera out to sabotage the whole video system). This will replace current security video camera widespread use of closed circuit television (CCTV) analog cable (which has a maximum total analog 400 Mega Hertz capacity for 6 Mega Hertz wide NTSC analog channels). A single 6 Mega Hertz wide cable analog audio/video channel is usually converted into a 30 Mega bits/second (downstream to the customer) and 2.4 Mega bits/second (back to the cable station) shared digital channel. The full digital broadband or multi-frequency capacity of the coaxial cable is about 1.0 Giga bits/second.

This is accomplished by the computerized or micro-processor/micro-controller controlled smart video sensor which will have a computer technology network interface card (NIC) built-in.

E). An advantage of the invention the preferred embodiment is to support the use of a video local area network (video-LAN) connected digital display device called a no-zone electronic rear view mirror. This is like the cross of a digital video game with a digital television giving very flexible, user selectable, real-time video displays which are digitally frame merged and digitally sequenced.

In mobile platform use, the digital display device is accomplished by a video telematics computer having integrated GPS satellite navigation receiver data, many communications channels, and integrated video channels.

F). An advantage of the invention the preferred embodiment is to support the video camera function of “electronic pan and tilt” which does not require a “warm blooded” human operator to mechanically “pan and tilt” or even a remote human operator to joy-stick “pan and tilt.” The “electronic pan and tilt” is an electronic focus mode which enhances a prior art passively focused charge coupled device (CCD). A passively focused charge coupled device (CCD) is prior art electronic contrast focusing which uses a CCD servo-feedback circuit to control mini-adjustments on a wide angled lens (this mimics a human camera operator doing fine lens adjustments for final focus upon a subject based upon his own brain's contrast readings). The invention's technology is meant for very high reliability, fully unattended, security video camera use with wide-angled lenses, fixed camera position (no operator or remote mechanical pan and tilt). However, the moving suspect is not automatically center framed and also not optically zoom lensed.

This is accomplished by the focal plane array based motion sensor, the micro-processor/micro-controller, and the passively focused CCD's. The micro-processor/micro-controller using the computer motion model for all moving suspects can do electronic frame centering or cropping and electronic enhancement or electronic scan line interpolation.

G). An advantage of the invention the preferred embodiment is to use of smart video cameras will allow non-human operator optical zoom and optical center framing from smart, micro-processor/micro-controller image processing firmware.

This is accomplished by an image processing program executed in the micro-processor/micro-controller. A computer motion model of all of the moving subjects can be simulated to allow digital enhancement (digital image enlargement with scan line interpolation) and digital image cropping. The resulting cropped digital image can be scan line interpolated for digital enhancement.

H). An advantage of the invention the preferred embodiment is to get close up, fully digital, Joint Photographer's Experts Group (JPEG I) digitally compressed still photo's of moving suspect's bodies and faces at different camera angles.

This is accomplished by the focal plane array based motion sensor.

I). An advantage of the invention the preferred embodiment is to get mid-range, simultaneous high resolution fully digital Joint Photographer's Experts Group (JPEG I) digitally compressed still photo's of moving suspect's bodies and faces at different camera angles.

This is accomplished by the focal plane array based motion sensor and the computerized motion model for all moving suspects.

J). An advantage of the invention the preferred embodiment is to produce a hybrid design, integrated, fully digitally compressed, Motion Picture Expert's Group (MPEG IV) video stream with I-Pictures only and no P-Pictures or B-Pictures to reduce timing slop which includes digital time and date stamps for each frame using a unique non-MPEG X cryptography “silhouette-like technique.” The MPEG IV video will be occasionally interspersed with the much higher resolution JPEG I still photos. This is called the new proposed MPEG IV Level S1/E1 Security/Entertainment Video format.

The new proposed MPEG IV Level S1/E1 (security camera/entertainment video) format is accomplished by the following means. The range to a particular motion model visible light image can also be estimated and kept in the motion model CCD coordinates by a much more inexpensive method which is a very low cost proposed ‘machine vision’ specialized use technique. A known marker such as a foot ruler marked highly visible 8-10 foot rule is permanently attached at a known distance from the camera. The foot ruler's focal plane CCD coordinates of (x, y, heat intensity, time, optional z-axis range) is user manually entered at camera set-up into the security video camera. The visible light digital image of the background benchmark ruler after passive auto-focus may be used in a simple measured reverse two 2-dimensional views to a single 3-dimensional computer model of the visible light moving suspect to give a range estimate (along the z-axis). This is similar to the age old practice of photographing fish from a fishing trip along with a foot ruler. The foot ruler technique will give a “3-dimensional computer image model” using visible light image data (MPEG IV supports opposite direction 3-dimensional moving texture maps to 2-dimensional displays or ‘3-Dimensional model slices’) and enough information to add range, image size, image shape information to the computer motion model's CCD coordinate data.

The MPEG X digitally compressed output macro-block groups of rows/single movie frame are collected in a first in first out (FIFO) buffer for DMA transfer over the micro-processor/micro-controller bus to the DRAM or faster SDRAM. A MPEG X ‘presentation time stamp (PTS)’ or n-bit digital stamp is periodically added in at intervals no less than 700 milli-seconds (7/10^{ths} of a second) to various MPEG X streams to correlate the different MPEG X digital data streams such as:

control stream,

video stream (presentation time stamped (PTS'd)),

with user data stream extensions such as tele-text, closed captioning for the hearing impaired, GPS satellite navigation data (uncorrelated with video), interactive television guide data, annotation data under a MPEG VII standard format,

audio stream (presentation time stamped (PTS'd)),

for replay with use of a target system hardware clock called a MPEG X play-back hardware digital timer ‘system time clock (STC),’ which is originally initialized to a digital time value in the initial MPEG X control stream called the ‘program clock reference (PCR).’ A play-back computer checks the ‘presentation time stamp (PTS)’ values with the current value of the original ‘program clock reference (PCR)’ initialized hardware time value about once a second. Re-synchronization can be done with skipping MPEG X frames or very minor speeding up or slowing down play-back speeds. The goal is to keep the replay frames as even as possible due to human eye sensitivity to ‘irregular motion jerk’ vs. ‘smooth and continuous motion.’

The use of a motion control computer heat image model for all moving heat images will allow sequenced or else selective focus upon one image at a time for a hybrid stream of both sharp still JPEG photographs mixed with general picture MPEG X audio/video data streams for time and motion studies in the new proposed MPEG X Level S1/E1 (Security and Entertainment Video) standard, which is new with this invention implemented in specialized MPEG X circuitry. This new format has ‘n-dimensional reality’ stream support for ‘GPS position stamping’ and ‘GPS time stamping’ for every motion study frame useful in security and crash recording which is accurate to 20 nonosecond at the GPS receiver and 1000 or less nanoseconds at the processor and the frame construction, potentially added to each and every frame of the video stream:

the standard MPEG X supervisory control stream with ‘presentation clock reference (PCR)’ the initialization value for the MPEG X play-back system's hardware digital clock called a ‘system clock reference (SCR)’,

the standard periodically ‘presentation time stamped (PTS'd)’ video stream with ‘silhouette technique (background scene cut and pasting)’ inserted into possibly up to each and every frame holding frame-stamps (e.g. GPS date, GPS time to 1 micro-second at the frame processor, GPS position to 100 feet or less (point position), GPS delta position (point velocity), inertial reference unit (IRU) angle position (‘stick airplane position’), IRU translation data (‘stick airplane’ velocity), video channel number, video channel set-up data such as foot ruler distance, pilot annotation data, interactive television guide data, closed captioning for the hearing impaired) on each and every frame using a minimum of at least one ‘cut and pasted’ MPEG X macro-block for the ‘silhouette technique’ which special macro-block is marked as non-compressible for other MPEG X compatible processes.

the standard ‘presentation time stamped (PTS'd)’ audio stream, a new very low rate periodic maximum JPEG X interspersed high resolution suspect/portrait shot stream which is also periodically ‘presentation time-stamped (PTS‘d)’, and

a possible ‘presentation time stamped (PTS'd)’ seat vibration theater effect stream,

a possible ‘presentation time stamped (PTS'd)’ olfactory control theater effect stream,

a possible ‘presentation time stamped (PTS'd)’ lighting control stream,

a possible ‘presentation time stamped (PTS'd)’ drapery control stream,

a possible ‘presentation time stamped (PTS'd)’ intermission ad control stream,

a possible ‘presentation time stamped (PTS'd)’ supervisory control stream possibly with a second stream for what used to be called 3-D (x, y, z) audio/video (e.g. Imax (R) Polarized (R) viewing glasses format, or timed LCD viewing glasses format) which must now be renamed to 2-N-D audio/video all recorded on DV-tape (R) format or else DVD-X (R) format. This function of electronic focus upon one out of many heat images using a computer motion control model is called “electronic pan and tilt.”

The new with this invention, proposed MPEG IV Level S1/E1 Security Video format will support variable parameters for customer selected digital bandwidth [bits/second] divided up into resolution [bits/frame]×progressive frame rate [frames/second]. A customer selected interlaced frame rate [½ frames/time interval] will also be supported. Motion studies require greater timing accuracy than standard MPEG I's up to one-half second timing slop between I-frames at a 3 Mega bit/second standard rate for a 360-line frame. On the other extreme, suspect identification photos require greater frame resolution than standard MPEG I 360-line frames.

(Future application) This may be accomplished in the future use of a custom chip set architecture used to support use of smart digital video cameras using a special future cryptographic micro-processor (C-CPU) chip-set (in the future possibly cost and size reduced to a single analog/digital mixed signal integrated circuit (IC), tamper resistant, crypto-micro-processor) technology. Each chip will have an inter-metallic grid with automatic impedance monitoring to detect chip hacker use of pin probers with automatic crypto memory erasure. The micro-processor bus will also do automatic impedance monitoring to detect chip hacker use of pin probers and bus probes with automatic crypto memory erasure. The basic crypto-strong-ARM chip-set will have separate chips for:

1). 512 Mega Hertz 32-bit micro-processor chip. Memory management logic.

2). Synchronous dynamic random access memory (SDRAM) chips. Able to store several 3-6 Mega pixel JPEG X uncompressed digital still photos.

3). peripheral 266 Mega Hertz 32-bit I/O bus support:

a). direct memory access (DMA) controllers Memory to port and port to memory for I/O bus ‘dumb’ byte level data shuffling

b). memory addressing logic (RAS/CAS)

c). priority interrupt controller (PIC)

d). counter timer circuit (CTC)

e). TNV-EEPROM for crypto key permanent storage with pass-thru encryption crypto key transfer from smart cards used as portable disk vaults.

f). bus impedance monitoring for chip hacker pin probing with automatic TNV-EEPROM erasure.

4). Integrated chip with MPEG X/proposed MPEG X level S1/E1 digital compression only. High rate audio/video stream MPEG X compression plus separate parallel channels of low rate still picture JPEG X compression plus lowest rate digital audio needing MPEG X digital compression. Separate I/O bus queuing using separate DMA to SDRAM is used. MPEG X stream assembly and control stream production. support for true color or 10-bits for red, 10-bits for green, 10-bits for blue (RGB) signals or 32-bit wide digital data per pixel.

5). IBM's (R) Data Encryption Standard (DES) circuitry secret key encryption using crypto-keys stored in TNV-EEPROM, with RS parity coding and MPEG X/proposed MPEG X level S1/E1 control stream package assembly all ready for I/O card MODEM or I/O card wireless MODEM output. DES operates on 64-bit cipher blocks with data clocked in at the same rate as out with an approximate 50 clock latency (meaning the entire output stream must be encrypted at once to avoid pipe-line stall with 0's fed in producing garbage data coming out). Separate I/O bus queuing to PCI bus SDRAM chip using on-chip bus master DMA is used. On-chip SRAM (level 1 back-side bus cache) in a back-side bus with on-chip DMA for on-chip queues will free up the PCI bus from bus contention.

Each single chip in the chip set must use impedance monitoring over the intermetallic bus to detect a chip hacker's pin probers which will result in erasure of cryptographic memory (TNV-EEPROM) holding confidential cryptographic keys. A chip-set will have impedance monitoring over inter-chip set computer busses for pin probers with erasure of crypto-memory (TNV-EEPROM) holding confidential cryptographic keys.

The goal is to directly output from the video camera over a connected local area network (LAN)/wireless LAN with PC based recording to digital video tape (e.g. DV (R) tape or mini-DV (R) tape) custom per user ‘cipher-text (session key hardware encrypted)’ or customized per user ‘streaming crypto-media.’ Cryptographic keys holding session keys (1-time secret keys) for decryption will be made portable with smart cards used as portable cryptographic key vaults.

Prior art 32-bit and 64-bit low cost 512 Mega Hertz micro-processors called strong advanced reduced instruction set computing (RISC) (strong-ARM) micro-processors which need a secondary peripheral support chip for I/O bus functions as well as I/O bus chips for various support functions. Some embodiments needing much through-put in [instructions/second (MIPS)] or [floating point instructions/second (MFLOPS)] may use an advanced strong reduced instruction set computing (RISC) micro-processor (strong-ARM) which needs additional peripheral support functions in separate integrated circuit basic two chip-set (IC's),

bank programmable electrically erasable programmable read only memory (banked EEPROM) (computer program store),

an intermetallic layer wire mesh on a single integrated circuit (IC) only used for a tamper detect field which will detect test probes from impedance loading and then erase the cryptographic memory,

tamper resistant non-volatile electrically erasable programmable read only memory (TNV-EEPROM) (crypto keys storage and crypto computer program store),

input/output (I/O) or peripheral bus,

memory/address micro-processor bus,

full dedicated bus-master direct memory access (DMA) controllers on the I/O motherboard functions

one micro-processor bus-master DMA channel dedicated for DRAM memory re-fresh,

counter timer circuits (CTC's),

programmable interrupt controller (PIC),

memory addressing logic (row address strobe (RAS)/column address strobe (CAS)),

network interface I/O card (NIC) fully digital I/O to a computer attached cable modem or a fiber optic LAN.

K). An advantage of the invention the preferred embodiment is to keep micro-processor/micro-controller processed motion control models of several moving suspects at once which will allow sharp focus for sequential still suspect photographs of each, will also allow sharp mid-range still photograph focus upon many moving suspects, and will also allow distance focus if no moving suspects are detected. This is called “electronic pan and tilt.”

This is accomplished by the digital motion control computer model tracking all moving heat suspects.

This is accomplished by the 1^{st} and 2^{nd} alternative embodiments by the reverse direction two view 2-dimensional to single view of 3-dimensional computer image modeling using the standard foot ruler placed at a known distance in the video background as an aid for angle measurements and moving suspect sizes and dimensions. MPEG IV supports 3-dimensional moving texture mapping in the reverse direction of 3-dimensional model to 2-dimensional view or ‘model slice’.

### IX). ADVANTAGES OF THE 1^{ST} ALTERNATIVE EMBODIMENT

L). An advantage of the 1^{st} alternative embodiment is very low cost, limited moving suspect tracking, with medium resolution JPEG photographs of only one or two moving suspects.

This is achieved by one or at most several infrared (IR) light emitting diodes (LED's) arranged in a small cluster facing in different directions with a single, low-cost, combined infrared (IR)/visible light, charge coupled device (focal plane CCD). The infrared (IR) heat image on the CCD gives a focal plane CCD coordinate of (x, y, image heat intensity, time, optional z-axis range) which is kept in a computer motion control model maintained for all stationary and moving suspects. The computer motion control model selects a single stationary or moving image and uses it's current CCD coordinate point of (x, y, image heat intensity, time, optional z-axis range) for passive auto-focus use with the visible light image. Passive auto-focus with an infrared or visible light image uses image contrast auto-focused by a servo-motor, closed loop, control lens. More than one stationary or moving heat image in the computer motion control model can either track the strongest heat image (image discrimination), or else the one shaped like a human being (using a 3-dimensional image model from the visible light image), or all objects of interest can be sequenced through by the computer motion model by using the “electronic pan and tilt” function.

Infrared ranging using the speed of light cannot be determined without a Global Positioning System (GPS) receiver or a cesium atomic clock standard.

The use of the micro-processor/micro-controller's motion control computer model can use the infrared/visible light focal plane array's CCD coordinates of (x, y, image heat intensity, time, optional z-axis range) measured at the infrared/visible light CCD. Possible sequenced coordinates of one to two moving suspects can be sent by the micro-processor/micro-controller to the infrared/visible light CCD to do “electronic pan and tilt” and passive auto-focus upon several suspects. “Electronic pan and tilt” in the micro-processor/micro-controller can use the CCD coordinate point of (x, y, image heat intensity) sent to the CCD to focus sequentially on moving suspects or to focus on one particular moving suspect.

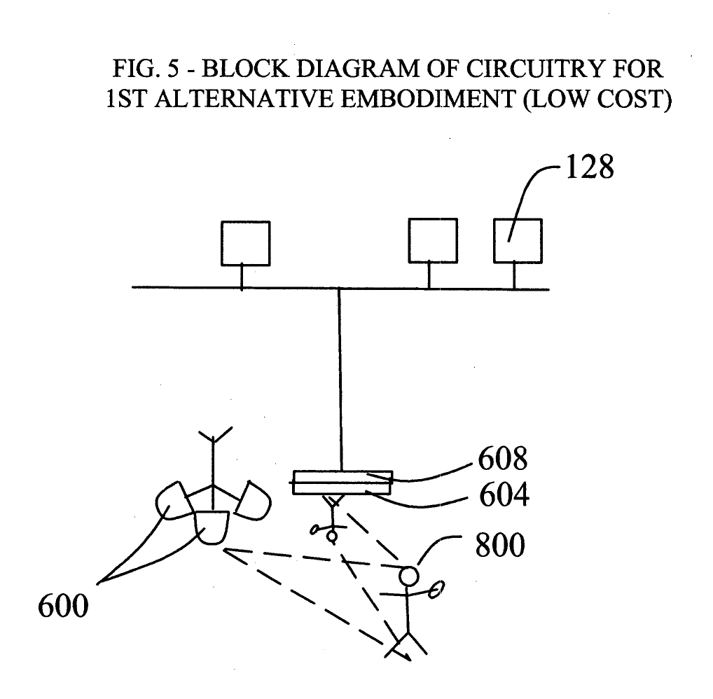

FIG. 5 is a diagram of the 1st alternative embodiment, medium cost, with a dedicated small cluster of infrared diodes pointing out in all outward directions and a single combined infrared/visible light focal plane array charge coupled device (focal plane CCD) to collect both heat images and visible light images.

### X). ADVANTAGES OF THE 2^{ND} ALTERNATIVE EMBODIMENT

M). An advantage of the 2^{nd} alternative embodiment is very high cost, large number of moving suspect tracking, with very high resolution still JPEG photographs of multiple moving suspects.

This is achieved by a dedicated full cluster of infrared (IR) light emitting diodes (LED's) facing in outward directions with a dedicated, single infrared (IR) charge coupled device (hybrid focal plane CCD) in a dedicated unit called a focal plane array. All infrared light emitting diodes (IR LED's) are simultaneously lit up to transmit light in all outward directions which is reflected off of a moving suspect(s) and each reflected light infrared image is picked up the single infrared CCD. A CCD coordinate of (x, y, image heat intensity, time) can be measured and sent to the micro-processor/micro-controller for use in a motion control computer model of more than one stationary and moving suspects. Ranging using the speed of light for infrared light or visible light cannot be determined without a Global Positioning System (GPS) receiver or a cesium atomic clock standard.

More than one still or moving heat image in infrared (IR) range will give multiple target images in the motion control computer model. A simple solution for this so called “image discrimination” or “target designation” problem is to track the strongest moving heat image or else the one shaped like a human being. The motion control computer model using the CCD coordinates of (x, y, image heat intensity, time, optional range) can be used to help in “target designation” or “image discrimination” to distinguish multiple moving heat sources.

The use of CCD coordinate points of (x, y, image heat intensity, time, optional range) for the micro-processor's motion control model is used to track every stationary or moving suspect in range. The “electronic pan and tilt” in the micro-processor/micro-controller's motion control computer model can use a single image's CCD coordinate point of (x, y) sent to the CCD to focus on only one particular stationary or moving suspect of interest.

A fixed foot ruled long measure with highly visible foot and inch markings in the lens field of view at a known distance technique can be used to give image ranges using a low-cost and low-computation “machine vision” foot ruler technique using two measured 2-dimensional images reverse combined into a single 3-dimensional model. A micro-processor/micro-controller maintained computer 3-dimensional image model (e.g. MPEG IV supports 3-dimensional texture mapping in the opposite direction of 3-dimensional computer model to 2-dimensional ‘model slice’ view) can use the known benchmarked foot ruler to give good image range, shape, and size estimates. The micro-processor/micro-controller maintained computer reverse two 2-dimensional view to single 3-dimensional image model will give calculated range estimates as well as image size, image shape, image spherical coordinates (alpha, beta, range), image speed, image heading which can all be added to the computer motion control model. The final computer motion control model focal plane array CCD coordinates will be for each point (x, y, image heat intensity, time, optional z-axis range, image size, image shape, image spherical coordinate alpha, image spherical coordinate beta, image spherical coordinate range, image speed, image heading).

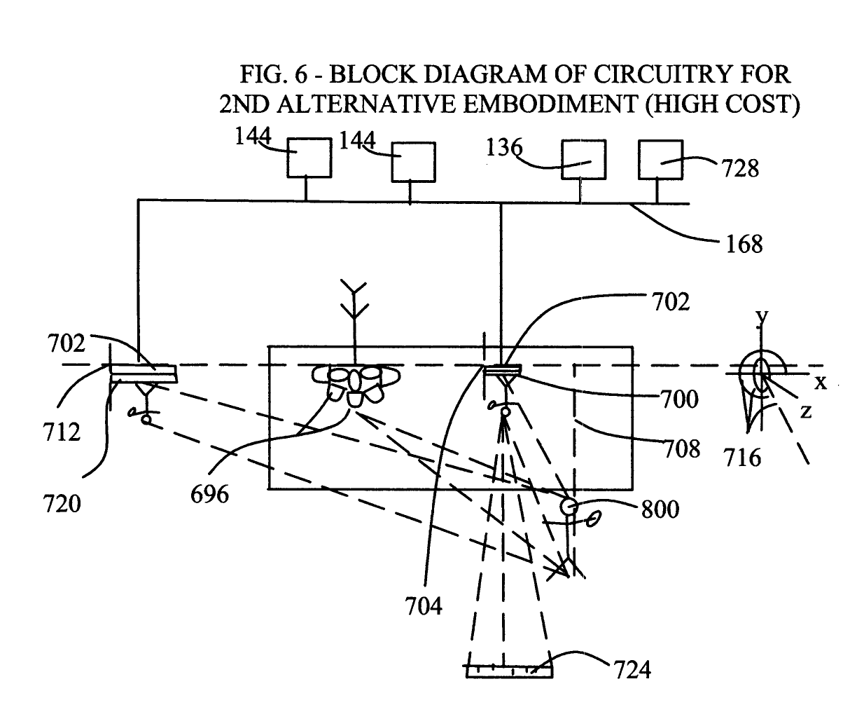

FIG. 6 is a diagram of the 2^{nd} alternative embodiment, highest cost, with a dedicated infrared light emitting diode (IR LED) array pointed in many different outward directions and a single, dedicated, infrared/visible light only charge coupled device (hybrid focal plane CCD) used to receive heat images and visible light images, as well as a dedicated advanced reduced instruction set computing (RISC) micro-processor (strong ARM) to do both computer motion control model and 3-dimensional image modeling on all moving heat image and visible light imaged suspects. A hybrid design with an ultra-sonic sound transmitter and an ultra-sonic receiver with sonar processing is possible.

### XI). SUMMARY OF THE INVENTION

A). This invention in the preferred embodiment gets rid of fuzzy frame buffer suspect ID photo's obtained from analog, NTSC security video cameras. It will also offer improved suspect photos over all digital compressed Digital Video (DV) video cameras which use DV (R) protocol digital compression, a non-MPEG compatible form of digital compression. It will also offer improved suspect photos over all digital compressed MPEG IV (R) video cameras recording to mini-DV (R) tape.

B). This invention in the preferred embodiment reduces the problem of grainy film wear using analog, NTSC security video signals on Dupont Mylar (R) film based 8 mm or Hi-8 mm video tape. Often even 10 overwrites of analog security video signals on brand new video tape produces graininess through hysteresis or magnetic field wear out which is also called magnetic coercivity.

C). This invention in the preferred embodiment supports fully digital recording over the video local area network (video-LAN) to digital tape drives. Digital tape drives use up/down recording tape instead of helical scanning VHS tape. Newer after y. 1999 digital video cameras use larger format intended for commercial filming use, Digital Video (DV (R)) compressed digital color audio/video signals which can be de-compressed into digital data for 480 viewable line digital signals. The DV (R) video signals can be stored upon digital magnetic tape through the use of an industry standard commercial format called mini-DV (R) which records upon mini-DV (R) video tape, or else upon wider format, and longer length, digital video DV (R) tape meant for commercial television and movie recording. These all digital formats are much less susceptible to film wear out from hysteresis (magnetic coercivity).

The older analog signal helical scanning video tape technology of analog signal video recording is replaced by up/down recording computer digital tape recording technology of much more robust and compact up and down magnetic bars of computer binary 1's and 0's for much greater video storage per foot of video tape. The mini-DV (R) tape cartridges introduced commercially after y. 1999 was much thinner and smaller than a comparable in recording time and video quality, analog National Television Standards Committee (NTSC) signal which was stored upon the much older Hi-8 (R) (8 mm) tape cartridge.

The invention will support the use of computer industry digital streaming tape drives with removable tape cartridges. In y. 2002, 300 Giga byte streaming tape cartridges are commercially used with 8 Mega byte/second per tape drive recording rates. A 300 Giga byte streaming tape cartridge will store 100,000 seconds of a very high data rate for motion recording MPEG IV format recording at a recording rate of 3 Mega bytes/second or 27 hours of full motion 30 frame/second audio/video.

The invention will support the use of digital versatile disk read/write (DVD−RW or DVD+RW) video recording. In y. 2002, single sided and single density DVD's have 7 times the capacity of a compact disk (CD) or seven×700 Mega bytes/CD for 4.9 Giga bytes/DVD. Double sided and double density DVD's can store four times 4.9 Giga bytes or this amount or 19.6 Giga bytes of data (at a single channel audio/video MPEG IV recording rate of 3 Mega bytes/second this will store about 6.5 thousand seconds or 1.8 hours of full motion recording at 30 frames/second which can be extended to 54 hours at a two frame/second freeze frame recording rate). A y. 1999 DVD is equivalent to a 24×CD in sustained data transfer rate or about 3.4 Mega bytes/second.

D). This invention in the preferred embodiment supports the use of a video camera connection to fully digital video local area networks (video-LAN's) using broadband cable modems (physical cable used as a straight line bus but logically looped and terminated channels which offer up to a maximum of 1 Giga bits/second digital bandwidth now available in y. 2002). Support future use of single mode (1 Giga bit/second digital bandwidth now available) and multi-mode fiber optic cable medium (100 Giga bit/second digital bandwidth now available). Fiber bus or star topologies supported with the star topologies using fast switching hubs much less vulnerable to vandalism or criminal sabotage (criminals may try to rip a bus based video camera out to sabotage the whole video system). This will replace current security video camera widespread use of closed circuit television (CCTV) analog, coaxial cable (which has a maximum total analog capacity of 400 Mega Hertz and a digital capacity of 1 Giga bits/second). In cable station use, a single 6 Mega Hertz wide analog cable video channel is usually converted into a 30 Mega bits/second (downstream to the customer) and 2.4 Mega bits/second (back to the cable station or cable head-end) shared by up to 30 homes per cable loop. The digital broadband capacity is used for digital cable modems at homes and businesses which must be shared or bandwidth divided by 1 up to 30 users per cable loop. The maximum digital broadband or multi-frequency capacity of the coaxial cable is about 1.0 Giga bits/second now supported by several broadband cable modem chip vendors on the cable head-end only for all digital cable systems.

E). This invention in the preferred embodiment supports the use of a video local area network (video-LAN) connected digital display device used as a very interactive and highly intuitive, man machine interface (MMI) called a no-zone electronic rear view mirror (nz-mirror) which gives enhanced eye-mind intuitive orientation and mental coordination for a fast response [REF 504, 512]. This is like the cross of a digital video game with a digital television with GPS satellite navigation and a communications channel giving very flexible, user selectable, real-time video displays which are digitally frame merged and digitally sequenced.

In mobile platform use, the digital display device with a computer and some form of communications channel is called a ‘video telematics’ video computer having integrated GPS satellite navigation receiver data, many communications channels, and integrated video channels for display. The very specialized digital video camera of this invention was originally designed as an add-in device for use in this system.

F). This invention in the preferred embodiment supports the completely unattended security, video camera function of “electronic pan and tilt” which does not require a “warm blooded” human operator to mechanically “pan and tilt” move or even remote control servo-motor “pan and tilt” move a video camera using a joy-stick. The “electronic pan and tilt” is an electronic focus mode which enhances a prior art passively focused charge coupled device (CCD). A passively focused charge coupled device (CCD) is prior art electronic contrast focused using a CCD with servo-feedback circuit to control mini-adjustments to a wide angled lens (this mimics a warm blooded human hand or remote human camera operator doing fine lens adjustments for final focus upon a subject based upon his own brain's contrast readings). The invention's technology is meant for very high reliability, fully unattended, security video camera use with wide-angled lenses, fixed camera position (no warm blooded operator or remote mechanical pan and tilt).

G). This invention in the preferred embodiment uses smart video cameras which allow non-human operator optical zoom and optical center framing from smart, micro-processor/micro-controller image processing firmware.

H). This invention in the preferred embodiment gives close up, fully digital, Joint Photographer's Experts Group (JPEG I) digitally compressed still photo's of moving suspect's bodies and faces at different camera angles.

I). This invention in the preferred embodiment gives mid-range, simultaneous, high resolution, fully digital Joint Photographer's Experts Group (JPEG I) digitally compressed still photo's of moving suspect's bodies and faces at different camera angles.

J). This invention in the preferred embodiment is useable to produce a hybrid design, integrated, fully digitally compressed, Motion Picture Expert's Group (MPEG IV) video stream with I-Pictures only and no P-Pictures and no B-Pictures to reduce timing slop which includes digital time and date stamps for each and every frame image using a unique non-MPEG X cryptography “silhouette-like technique.” The MPEG IV video will be occasionally interspersed with the much higher resolution JPEG I still photos. This is called the proposed MPEG IV Level S1/E1 (Security Video/ Entertainment Video) format (proposed new MPEG standard with this invention). The traditional MPEG IV video stream and audio stream using ‘MPEG presentation time stamps’ will be supplemented with a very low rate JPEG I high resolution still photo stream also ‘MPEG presentation time stamped’ as well as the introduction of the ‘silhouette technique’ used to add to each and every video frame a specially ‘cut and pasted’ in background area: possible GPS date, GPS time (good to about 1000 nano-seconds), GPS position in latitude, longitude, altitude, GPS delta position in delta latitude, delta longitude, delta altitude, camera channel, user annotation text, possible weather data text, ground terrain map digital data, etc.

K). This invention in the preferred embodiment is usable to keep micro-processor/micro-controller processed motion control models of several moving suspects at once which will allow sharp focus for sequential still suspect photographs of each, will also allow sharp mid-range still photograph focus upon many moving suspects, and will also allow distance focus if no moving suspects are detected. This is called “electronic pan and tilt.”

L). This invention in the 1^{st} alternative embodiment is a very low cost, fully automated, limited moving suspect tracking, with medium resolution JPEG photographs of only one or two moving suspects.

M). This invention in the 2^{nd} alternative embodiment is a focal plane array based system is very high cost, fully automated, large number of moving suspect tracking, with very high resolution still JPEG photographs of multiple moving suspects.

The specifications of this patent have given some sample embodiments to associate a structure with the invention. These specific mentioned embodiments should not be construed as limitations on the legal claims of the invention, but, rather as exemplifications of the invention thereof. Many other embodiments are possible. For example, MPEG I, MPEG II, and MPEG IV are backwardly compatible in time and downwardly compatible in functionality and may be interchanged to a limited extent. Motion JPEG can be used instead of MPEG X. Digital Video (R compressed digital video which is not compatible with MPEG X can be used instead of MPEG X. JPEG can be substituted with JPEG 2000, but, these are non-compatible standards. The user data stream extensions of MPEG II and MPEG IV can be used instead of the non-MPEG X “silhouette-like technique” used in this invention for the storing of time stamps, Global Positioning System (GPS) satellite navigation position stamps, video camera set-up attitude data, video channel data, and electronic television guide data. Many different forms of focal plane array based motion sensors are possible such as low-cost infrared diode clusters used with a single combined infrared/visible light charge coupled device (CCD), or else a high-cost, focal plane array composed of a dedicated infrared diode emitter array cluster used with a single or multiple dedicated infrared (IR) charge coupled device (CCD) with a single or multiple dedicated visible light charge coupled device (CCD), or else a high-cost, hybrid focal plane array design using an infrared diode array combined with an infrared/visible light charge coupled device (CCD) with a dedicated visible light charge coupled device (CCD) or multiple visible light CCD's arranged in an array, plus a redundant ultra-sonic sound emitter array used with a multi-channel micro-phone array for sonar processing, which can all measure a stationary or moving suspect's focal plane array CCD coordinates of (x, y, heat image intensity, time, optional z-axis range) maintained in a motion control computer model kept for all images of interest in the invention. Many alternative types of hybrid JPEG and MPEG X output data stream can be used. The legal scope of the invention should be determined by the accompanying claims and not by the limited embodiments given.

1. I claim an invention which is specialized for use in a low cost, low security environment with both unattended and attended operation with means for specialized post-crime, suspect identification using digital, audio/video security recording which is composed of the elements of:
a camera body,
a closed loop servo-motor controlled passively auto-focused camera lens optimized for motion video use, furthermore with means for use as a gain-box (G-box),
a closed loop servo-motor controlled passively auto-focused camera lens optimized for still photographic use, furthermore with means for use as a gain-box (G-box),
a transmissive motion sensor,
a micro-processor with means for output compressed digital data stream final assembly, furthermore with means for very rapid closed loop servo-motor control processing of the H-boxes and the G-boxes, furthermore with means for suspect motion computer modeling,
peripheral input/output (I/O) bus and timing circuitry,
micro-processor input/output I/O peripheral chips,
a passively focused Moving Picture Expert's Group X like (MPEG X-like) optimized both infrared and visible light receptive charge coupled device (MPEG-like CCD) which is used with means as a hold-box (H-box) signal generator for closed loop servo motor control algorithms executed in the micro-processor used in lens servo-motor control,
a passively focused Joint Photographer's Expert's Group like (JPEG-like) optimized visible light receptive charge coupled device (JPEG CCD) which is used with means as a Hold-box (H-box) signal generator for closed loop servo motor control algorithms executed in the micro-processor used in lens servo-motor control,
a high rate analog to digital converter (ADC) with means for converting the MPEG X-like charge coupled device (CCD) output analog audio and video signals to digital with means for micro-processor bus input into the dedicated digital compression circuitry, furthermore with means to act as a hold-box (H-box) for closed loop servo-motor MPEG X-like lens control,
a low rate analog to digital converter (ADC) with means for converting the JPEG X-like charge coupled device (CCD) output analog video signals to digital with means for micro-processor bus input into the dedicated digital compression circuitry, furthermore with means to act as a hold-box. (H-box) for closed loop servo-motor JPEG X-like lens control,
a very low rate analog to digital converter (ADC) with means for converting the two channels of analog audio from a line amplified micro-phone into MPEG X-like digitized audio with means for micro-processor bus input into the dedicated digital compression circuitry,
a MPEG X like specialized digital compression circuit,
a JPEG X like specialized digital compression circuit,
dynamic random access memory (DRAM) for temporary data store with means for holding large 6 mega pixel JPEG X-like frames,
electrically erasable programmable read only memory (EEPROM) for permanent computer program store,
static RAM (SRAM) for small amounts of fast micro-processor program variables storage,
a first in first out buffer (FIFO),
a removable permanent memory storage device for digital data with first example means of a digital video tape cassette,
a power supply,
which elements are electronically and mechanically combined together into a specialized, hybrid simultaneously recorded JPEG like and MPEG X-like digital audio/video camera, which furthermore simultaneously produces a high data rate audio/video stream of MPEG X like compressed digital video signals, and also at the same time a very low rate much higher resolution still photograph stream of JPEG X like still suspect photographs with first application means for post-crime suspect identification and capture, and with second application means for professional filming for commercial entertainment movies and shows.

2. The invention of claim 1 whereby the passively, auto-focused camera lens may be of a unit count of two with one closed loop servo-motor controlled lens dedicated to a specialized MPEG X like charge coupled device (CCD) and one closed loop servo-motor controlled lens dedicated to a specialized JPEG X like charge coupled device (CCD).

3. The invention of claim 1 whereby the transmissive motion sensors are example means of infrared diode (IR) emitters arranged in a focal plane array, furthermore, the infrared diodes are aimed outwards at all directions.

4. The invention of claim 1 whereby the transmissive motion sensors are example means of infrared (IR) heat diode emitters arranged in a focal plane array aimed at different outwards directions, furthermore the reflected off a moving target infrared heat hot spot is received by a combined infrared and visible light MPEG like CCD sensitive to reflected heat images.

5. The invention of claim 1 whereby the micro-processor with separate elements of an input and output (I/O) bus, furthermore with separate elements of interrupt and timing circuitry keeps a means for suspect computer motion modeling by software algorithm using the input data from the combined infrared and visible light MPEG like CCD of both still and moving heat image CCD coordinates of (x, y, image heat intensity, time, optional z-axis range using a machine vision algorithm).

6. The invention of claim 1 whereby the closed loop servo-motor controlled passively auto-focused camera lens optimized for wide-angle motion video use, receives from the micro-processor's computer motion model the motor controls for a single suspect of interest and does micro-processor bus latch to discrete analog control circuitry lens motion.

7. The invention of claim 1 whereby the closed loop servo-motor controlled passively auto-focused camera lens optimized for wide-angle still photographic use, receives from the micro-processor's computer motion model the motor controls for a single suspect suspect of interest and does micro-processor bus latch to discrete analog control circuitry lens motion.

8. The invention of claim 1 whereby the analog to digital converter (ADC) converts all CCD output from analog to digital with means for processing groups of video rows (macro-blocks) of a single movie frame conversion, furthermore with means for processing groups of video rows of a single still frame, furthermore with means processing audio streams of data.

9. The invention of claim 1 whereby the MPEG X like digital compression circuitry has means for processing rows of video (macro-blocks) from a single movie frame, furthermore it has means for color model conversion, furthermore it has means for a digital compression algorithm which can distinguish ‘visually unimportant data’ for selective drop out in lossy data compression, furthermore it has means for adding error detection and correction parity bits, furthermore it has means for using the micro-processor bus to deposit the groups of video rows (macro-blocks) into DRAM memory in an eventual complete movie frame which is given the MPEG X like ‘presentation time stamp,’ furthermore the MPEG X like chip inputs digital sound from two audio analog to digital converters (ADC's) and digitally compresses the two channels using the MPEG X like audio digital compression standard for audio stream output with MPEG X like ‘presentation time stamps.’

10. The invention of claim 1 whereby the JPEG X like digital compression circuitry has means for processing rows of video from a single still picture frame, furthermore it has means for color model conversion, furthermore it has means for a digital compression algorithm which can distinguish ‘visually unimportant data’ for selective drop out in lossy data compression, furthermore it has means for adding error detection and correction parity bits, furthermore it has means for using the micro-processor bus to deposit the groups of still picture rows into DRAM memory in an eventual complete still picture frame which has the MPEG X like ‘presentation time stamp.’

11. The invention of claim 1 whereby the dynamic random access memory (DRAM) is used for temporary data store of actions with micro-processor means for collecting from both the MPEG X like and JPEG X like digital compression chips the groups of rows of video for a single-frame until a completed either movie MPEG X like frame or still picture JPEG X like frame is assembled, furthermore with means collecting a MPEG X like digitally compressed audio stream, furthermore with means for MPEG X like control stream assembling the various streams into a hybrid output data stream called the new with this invention the proposed MPEG IV Level S1/E1 which furthermore uses an efficient frame re-ordering means.

12. The invention of claim 1 whereby the electrically erasable programmable read only memory (EEPROM) has means for permanent computer program store.

13. The invention of claim 1 whereby the first in first out buffer (FIFO) is used to connect an input and output (I/O) bus device to computer memory.

14. The invention of claim 1 whereby the output audio and video stream recorded is a new with this invention proposed MPEG X like level called the new proposed MPEG IV level S1/E1 format for security level 1 1^{st} means, furthermore for entertainment level 1 2^{nd} means, furthermore using hybrid MPEG X like digitally compressed audio/video along with a much lower rate stream of still JPEG like digitally compressed, higher resolution, photos.

15. The invention of claim 13 whereby the new proposed MPEG X level S1/E1 for security level 1 1^{st} means, furthermore for entertainment level 1 2^{nd} means, furthermore holds digital data with example means being GPS satellite navigation date, GPS time accurate to 1 micro-second at the recording, GPS latitude, GPS longitude, GPS altitude, delta GPS position, attitude data from an inertial reference unit (stick plane data), video channel data, pilot text notes, terrain map data, interactive television guide data in a “silhouette-like” cryptography technique in potentially every frame using static background areas to store data.

16. The invention of claim 1 whereby the removable permanent memory device is a digital video tape cassette.

17. The invention of claim 1 whereby the removable permanent memory device is remotely connected to the video camera through a video local area network (video-LAN) with a first example means being a broadband cable network.

18. The invention of claim 1 whereby the removable permanent memory device is remotely connected to the video camera through a video local area network (video-LAN) with a second example means being a fiber optic network.

19. The invention of claim 1 whereby the power supply is a nickel cadmium (“ni cad”) battery re-charged by a separate power line in the video local area network (V-LAN).

20. I claim an invention which is specialized for use in a medium cost, medium security environment with both unattended and attended operation with means to monitor only several moving suspects where specialized post-crime, suspect identification is desired using digital, audio/video security recording which is composed of the elements of:
a camera body,
a closed loop servo-motor controlled passively auto-focused camera lens optimized for motion video use, furthermore with means for use as a gain-box (G-box),
a closed loop servo-motor controlled passively auto-focused camera lens optimized for still photographic use, furthermore with means for use as a gain-box (G-box),
a focal plane array based transmissive motion sensor which aims out in different directions,
a single receiver using a dedicated both infrared and visible light charge coupled device (focal plane CCD),
a micro-processor with means for output compressed digital data stream final assembly, furthermore with means for very rapid closed loop servo-motor control processing of the H-boxes and the G-boxes, furthermore with means for suspect motion computer modeling,
peripheral input and output (I/O) bus and timing circuitry,
micro-processor input/output I/O peripheral chips,
a passively focused Moving Picture Expert's Group X like (MPEG X-like) optimized both infrared and visible light receptive charge coupled device (MPEG-like CCD) which is used with means as a hold-box (H-box) signal generator for closed loop servo motor control algorithms executed in the micro-processor used in lens servo-motor control,
micro-processor input/output I/O peripheral chips,
a passively focused Moving Picture Expert's Group X like (MPEG X-like) optimized both infrared and visible light receptive charge coupled device (MPEG-like CCD) which is used with means as a hold-box (H-box) signal generator for closed loop servo motor control algorithms executed in the micro-processor used in lens servo-motor control,
a passively focused Joint Photographer's Expert's Group like (JPEG-like) optimized visible light receptive charge coupled device (JPEG CCD) which is used with means as a Hold-box (H-box) signal generator for closed loop servo motor control algorithms executed in the micro-processor used in lens servo-motor control,
analog to digital converters (ADC's),
a simultaneous-mode MPEG X/JPEG X digital compression circuit,
dynamic random access memory (DRAM) for temporary data store with means for holding large 6 mega pixel JPEG X-like frames,
electrically erasable programmable read only memory (EEPROM) for permanent computer program store,
static RAM (SRAM) for small amounts of fast micro-processor program variables storage,
a first in first out buffer (FIFO),
a removable permanent memory device for digital data with first example means of a digital video tape cassette,
a power supply,
which elements are electronically and mechanically combined together into a specialized, hybrid simultaneously recorded JPEG like and MPEG X like digital audio/video camera, which furthermore simultaneously produces a high data rate audio/video stream of MPEG X like compressed digital video signals, and also at the same time a very low rate much higher resolution still photograph stream of JPEG X like still suspect photographs with first application means for post-crime suspect identification and capture, and with second application means for professional filming for commercial entertainment movies and shows.

21. The invention of claim 20 whereby the passively, auto-focused camera lens may be of a unit count of two with one closed loop servo-motor controlled lens dedicated to a specialized MPEG X like charge coupled device (CCD) and one closed loop servo-motor controlled lens dedicated to a specialized JPEG X like charge coupled device (CCD).

22. The invention of claim 20 whereby the focal plane array based motion sensor has infrared (IR) heat diode emitters aimed outwardly at all different directions with a redundant infrared (IR) charge coupled device integrated with a visible light charge coupled device (focal plane CCD) to pick up both reflected heat and visible light image of a moving suspect.

23. The invention of claim 22 whereby the micro-processor/micro-controller with input and output (I/O) bus and timing circuitry reads the combined infrared light and visible light charge coupled device's (focal plane CCD's) measured (x, y, image heat intensity, time) to maintain a computer motion model of all still or moving heat images.

24. The invention of claim 23 whereby the passively focused, infrared and visible light, charge coupled device (focal plane CCD) with lens feed-back circuitry, uses the stereo vision or 2-video channels to create a 3-dimensional computer image modeling to measure a standard foot ruled tape marking placed in the camera view at a user micro-processor/micro-controller programmed fixed distance at camera center with means to compute a three dimensional image 3-D computer model from which to micro-processor/micro-controller generate a computer 2-D slice across the z-axis gives the z-axis range to suspect estimates which it gives to the micro-processor/micro-controller to also maintain in the computer motion model.

25. The invention of claim 20 whereby the closed loop servo-motors for both the MPEG-X like lens and the JPEG-X like lens are fed by the micro-processor/micro-controller into their gain-boxes (G-boxes) the desired motor value to move the focal point of the lens with a rapid continuous course and then fine feed-back path which is called auto-focus.

26. The invention of claim 20 whereby the analog to digital converter (ADC) converts any analog output from first means of the MPEG-X like CCD, and second means of the JPEG-X like CCD, and third means of the line amplified analog audio signal from two micro-phones, from analog to digital.

27. The invention of claim 20 whereby a simultaneous-mode MPEG X/JPEG X digital compression circuit can simultaneously compress both separate streams of high rate and medium resolution per frame MPEG X and low rate and high resolution per frame JPEG X digital data.

28. The invention of claim 20 whereby the dynamic random access memory (DRAM) is used for temporary data store of large digital video data for buffered storage accessed by micro-processor/micro-controller means for collecting CCD to ADC digitized output of first example means of a single uncompressed digital JPEG still video frame, and second example means of a single uncompressed digital MPEG X moving video frame, and with micro-processor/micro-controller means for sending arbitrary rows of a single frame at once to the simultaneous-mode MPEG X/JPEG X compression circuit, and with micro-processor/micro-controller means for storing and assembling in DRAM both the MPEG X and JPEG X compressed digital data into an output data stream.

29. The invention of claim 20 whereby the electrically erasable programmable read only memory (EEPROM) has means for permanent computer program store.

30. The invention of claim 20 whereby the first in first out buffer (FIFO) is used to connect an input/output (I/O) bus device to computer memory.

31. The invention of claim 20 whereby the output data stream recorded is a new MPEG X extension called proposed MPEG X level S1/E1 for a first application means of security level 1, furthermore, as a second application means for entertainment level 1, furthermore, with means for hybrid storage of the proposed MPEG X level S1/E1 compressed digital format which is comprised of moving MPEG X like audio/video as well as higher resolution still JPEG X like digital still photographs.

32. The invention of claim 31 whereby the proposed MPEG X level S1/E1 data stream holds extra inserted digital data in a “silhouette-like” cryptography technique potentially in every frame for frame stamping using static background areas of the video with first example means being GPS date, second example means being GPS time to within 1 micro-second at the recording, third example means being GPS satellite navigation position stamps (point data), fourth example means being GPS satellite navigation delta position stamps (point movement data), fifth example means being inertial reference unit angle data (‘stick airplane data’), sixth example means being inertial reference unit translation data (‘velocity data’), seventh example means being video camera channel.

33. The invention of claim 20 whereby the removable permanent memory device is a digital video tape cassette.

34. The invention of claim 20 whereby the removable permanent recording device is remotely connected through a video local area network with an example means being a broadband cable network.

35. The invention of claim 20 whereby the removable permanent recording device is remotely connected through a video local area network (V-LAN) with an example means being a fiber optic network.

36. The invention of claim 30 whereby the power supply is attached to the video local area network and is delivered over power pins.

37. I claim an invention which is specialized for use in a low cost, low security environment with both unattended and attended operation with means to monitor at most several moving suspects where means for specialized post-crime, suspect identification is desired using means of digital, audio/video security recording which is composed of the elements of:
a camera body,
a closed loop servo-motor controlled passively auto-focused camera lens,
a transmissive motion sensor which aims out in at least one direction,
a passively focused both infrared and visible light receptive charge coupled device (CCD) which is used with means as a signal generator for closed loop servo motor control algorithms used in lens servo-motor control,
an analog to digital converter,
a micro-processor/micro-controller with means for output compressed digital data stream final assembly, furthermore with means for very rapid multi-cycle closed loop servo-motor control processing for the lens assembly, furthermore with means for suspect motion computer modeling,
peripheral input and output (I/O) bus and timing circuitry,
micro-processor input/output I/O peripheral chips,
analog to digital converters (ADC's),
a digital compression circuit,
dynamic random access memory (DRAM) for temporary data store with means for holding large 6 mega pixel JPEG X-like frames,
electrically erasable programmable read only memory (EEPROM) for permanent computer program store,
static RAM (SRAM) for small amounts of fast micro-processor program variables storage,
a removable permanent memory device for digital data with first example means of a digital video tape cassette, and second example means being a memory card,
a power supply,
which elements are electronically and mechanically combined together into a specialized, hybrid simultaneously recorded JPEG X like and MPEG X like digital audio/video camera, which furthermore simultaneously produces a high data rate audio/video stream of MPEG X like compressed digital video signals, and also at the same time a very low rate much higher resolution still photograph stream of JPEG X like still suspect photographs with first application means for post-crime suspect identification and capture, and with second application means for professional filming for commercial entertainment movies and shows.

38. The invention of claim 37 whereby the passively, auto-focused camera lens may be of a unit count of two with one closed loop servo-motor controlled lens dedicated to a specialized MPEG X like charge coupled device (CCD) and a second closed loop servo-motor controlled lens dedicated to a specialized JPEG X like charge coupled device (CCD).

39. The invention of claim 37 whereby the motion sensor emitter has a infrared (IR) heat diode emitter aimed outwardly in at least one direction.

40. The invention of claim 39 whereby the micro-processor/micro-controller with input and output (I/O) bus and timing circuitry reads the combined infrared light and visible light charge coupled device's measured (x, y, image heat intensity, time) to maintain a computer motion model of all still or moving heat images.

41. The invention of claim 39 whereby the closed loop servo-motors for both the MPEG-X like lens and the JPEG-X like lens are fed by the micro-processor/micro-controller into their gain-boxes (G-boxes) the desired motor value to move the focal point of the lens with a rapid continuous course and then fine feed-back path which is called auto-focus.

42. The invention of claim 39 whereby the analog to digital converter (ADC) converts any analog output from first means of the MPEG-X like CCD, and second means of the JPEG-X like CCD, and third means of the line amplified analog audio signal from two micro-phones, from analog to digital for micro-processor/micro-controller bus reading and eventual digitizing.

43. The invention of claim 39 whereby a simultaneous-mode MPEG X/JPEG X digital compression circuit can simultaneously compress both separate streams of high rate and medium resolution per frame MPEG X and low rate and high resolution per frame JPEG X digital data as well as very low rate MPEG X two-channel audio data.

44. The invention of claim 39 whereby the dynamic random access memory (DRAM) is used for temporary data store of large digital video data for buffered storage accessed by micro-processor/micro-controller means for collecting the CCD joined with ADC digitized output of first example means of completed JPEG X like standard rows of a single uncompressed digital JPEG still video frame, and second example means of completed rows of MPEG X like standard macro-block rows of a single uncompressed digital MPEG X moving video frame, and with micro-processor/micro-controller means for sending arbitrary numbers of standard rows of a single frame at once to the simultaneous-mode MPEG X/JPEG X compression circuit, furthermore with micro-processor/micro-controller means for storing and assembling in DRAM a MPEG X like control stream along with both the MPEG X like and JPEG X like compressed digital data into an output data stream.

45. The invention of claim 39 whereby the electrically erasable programmable read only memory (EEPROM) has means for permanent computer program store.

46. The invention of claim 39 whereby the output data stream recorded is a new MPEG X extension called proposed MPEG X level S1/E1 for a first application means of security level 1, furthermore, as a second application means for entertainment level 1, furthermore, with means for hybrid storage of the proposed MPEG X level S1/E1 compressed digital format which is comprised of a MPEG X like control stream, furthermore high rate and medium resolution moving MPEG X like audio/video with MPEG X like presentation time stamps, furthermore low rate and higher resolution still JPEG X like digital still photographs with MPEG X like presentation time stamps, furthermore additional data streams of interest with MPEG X like presentation time stamps.

48. The invention of claim 47 whereby the proposed MPEG X level S1/E1 data stream holds extra inserted digital data in a ‘silhouette-like’ cryptography technique potentially in every frame using static background areas of the video with 1^{st} example means being GPS satellite navigation date stamps, very accurate time stamps, and position stamps.

49. The invention of claim 37 whereby the removable permanent memory device is a digital video tape cassette.

50. The invention of claim 37 whereby the removable permanent recording device is remotely connected through a video local area network with an example means being a broadband cable network.

51. The invention of claim 37 whereby the removable permanent recording device is remotely connected through a video local area network (V-LAN) with an example means being a fiber optic network.

52. The invention of claim 37 whereby the power supply is attached to the video local area network and is delivered over power pins.
